(19) United States
(12) Patent Application Publication
(10) Pub. No.: US 2015/0371408 A1
(43) Pub. Date: Dec. 24, 2015

(54) Vehicle Informatin Display System and Methods

(71) Applicant: Johnson Controls Technology Company, Holland, MI (US)

(72) Inventors: Steven G. Schultz, Holland, MI (US); Ryan Spoelhof, Grand Rapids, MI (US); James Farber, Holland, MI (US)

(21) Appl. No.: 14/307,622

(22) Filed: Jun. 18, 2014

(51) Int. Cl. G06T 11/00; B60K 35/00; G02B 27/01

(52) U.S. Cl. CPC G06T 11/001; G02B 27/01; B60K 35/00; B60K 2350/1072

(57) ABSTRACT

An apparatus for displaying information to an occupant of a vehicle including a display coupled to the vehicle, the display configured to display an image based on information stored in a frame buffer, and a control circuit coupled to the display, the control circuit configured to receive information related to the vehicle from a vehicle electronics system, wherein the control circuit is configured to display a digital instrument based on the information related to the vehicle by revealing a color gradient bitmap background using a bitmap mask and storing the result in the frame buffer, and wherein the bitmap mask is moved relative to the color gradient bitmap.

### BACKGROUND

The present invention relates generally to the field of automotive information displays such as instrument clusters, head-up displays (HUD), and center counsel displays. Vehicle information may be displayed to a driver or occupant of a vehicle using one or more displays located within the vehicle. Physical instruments such as tachometers and speedometers may be replaced with digital gauges. Digital gauges may be produced using on-board processors memory and/or other computer hardware. In some cases, a single processor or group of processors may generate images corresponding to multiple or all digital gauges in a vehicle. It is challenging and difficult to develop digital instruments which require less processing time or power, and thereby do not negatively impact the performance of digital instrument or other digital instruments displayed using the same processor or group of processors. Furthermore, it is challenging and difficult to develop digital instruments which convey information to a vehicle occupant in an easily readable manner and which efficiently use space available on one or more displays of a vehicle.

### SUMMARY

One embodiment relates to an apparatus for displaying information to an occupant of a vehicle including a display coupled to the vehicle, the display configured to display an image based on information stored in a frame buffer, and a control circuit coupled to the display. The control circuit may be configured to receive information related to the vehicle from a vehicle electronics system, and the control circuit may be further configured to display a digital instrument based on the information related to the vehicle by revealing a color gradient bitmap background using a bitmap mask and storing the result in the frame buffer, wherein the bitmap mask is moved relative to the color gradient bitmap.

Another embodiment relates to a method for displaying vehicle information to a vehicle occupant, including receiving, at a control circuit, information related to a vehicle from a vehicle electronics system, processing the information related to the vehicle using the control circuit to result in vehicle information, determining bitmap mask translation values based on the vehicle information, translating a bitmap mask based on the bitmap translation values, filling a frame buffer by revealing a portion of a color gradient bitmap background using the bitmap mask, and displaying the vehicle information on a vehicle display based on the frame buffer.

Another embodiment relates to a digital gauge for displaying information to an occupant of a vehicle, including a display coupled to the vehicle, a vehicle electronics system configured to provide information related to the vehicle, and a control circuit configured to provide information to the vehicle occupant by causing the display of vehicle information on the display. The vehicle information displayed may be an icon which changes color as it moves relative to a boundary of the digital gauge.

### BRIEF DESCRIPTION OF THE DRAWINGS

FIG. 1 is an illustration of an exemplary vehicle which may include a friction bubble or other digital instrument according to an exemplary embodiment.

FIG. 2 illustrates displays of a vehicle and a friction bubble digital instrument according to an exemplary embodiment.

FIG. 3 illustrates a block diagram of the hardware components of a digital instrument system according to an exemplary embodiment.

FIG. 4 illustrates display location for a friction bubble gauge according to an exemplary embodiment.

FIG. 5 illustrates a friction bubble gauge and the components of the image displayed according to an exemplary embodiment.

FIG. 6A illustrates a color gradient bitmap background used in the generation of a friction bubble gauge according to an exemplary embodiment.

FIG. 6B illustrates a bitmap mask used in the generation of a friction bubble gauge according to an exemplary embodiment.

FIG. 6C illustrates a labels bitmap used in the generation of a friction bubble gauge according to an exemplary embodiment.

FIG. 7A illustrates an alternative color gradient bitmap background having quadrants according to an exemplary embodiment.

FIG. 7B illustrates an alternative color gradient bitmap background having concentric regions according to an exemplary embodiment.

FIG. 7C illustrates an alternative labels bitmap according to an exemplary embodiment.

FIG. 8A illustrates a bitmap resulting from the combination of a color gradient bitmap background and bitmap mask during vehicle acceleration to the left according to an exemplary embodiment.

FIG. 8B illustrates a bitmap resulting from the combination of a color gradient bitmap background and bitmap mask during vehicle acceleration to the left and forward according to an exemplary embodiment.

FIG. 8C illustrates a bitmap resulting from the combination of a color gradient bitmap background and bitmap mask during vehicle deceleration according to an exemplary embodiment.

FIG. 8D illustrates a bitmap resulting from the combination of a color gradient bitmap background and bitmap mask during vehicle acceleration to the right according to an exemplary embodiment.

FIG. 9A illustrates a color gradient bitmap background of a nested friction bubble gauge according to an exemplary embodiment.

FIG. 9B illustrates a friction bubble gauge nested within a tachometer according to an exemplary embodiment.

FIG. 10 illustrates a flow chart showing a technique for displaying a friction bubble gauge according to an exemplary embodiment.

FIG. 11A illustrates vehicle acceleration and the corresponding changes in the displayed friction bubble gauge 240 for an acceleration based system according to an exemplary embodiment.

FIG. 11B illustrates vehicle acceleration and the corresponding changes in the displayed friction bubble gauge 240 for an acceleration and g force acceleration component based system according to an exemplary embodiment.

FIG. 12 illustrates a flow chart showing a technique for displaying a digital instrument according to an exemplary embodiment.

FIG. 13A illustrates an exemplary embodiment of a track position gauge implemented as a digital instrument.

FIG. 13B illustrates exemplary embodiments of a mask, color gradient bitmap background, and labels bitmap for generating a track position gauge.

### DETAILED DESCRIPTION

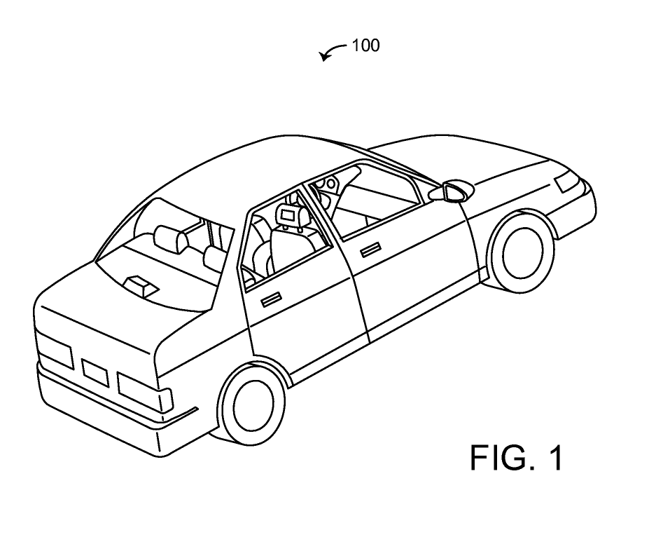

Referring to FIG. 1, a vehicle may include one or more digital instruments for displaying vehicle information to a vehicle occupant. A vehicle may be or include a land based vehicle such as an automobile (e.g., a car, sport utility vehicle, truck, bus, etc.). A land based vehicle may include an interior space for a driver and/or occupants (e.g., a car with a cabin). A land based vehicle may also include be open (e.g., a convertible motorcycle, etc.). A land based vehicle may be wheeled or travel using other proposition devices (e.g., a tracked vehicle such as a snowmobile). In some embodiments, one or more digital instruments as described herein are included in other vehicles such as air (e.g., airplanes, helicopters, etc.) or water based vehicles (e.g., boats, ships, etc.).

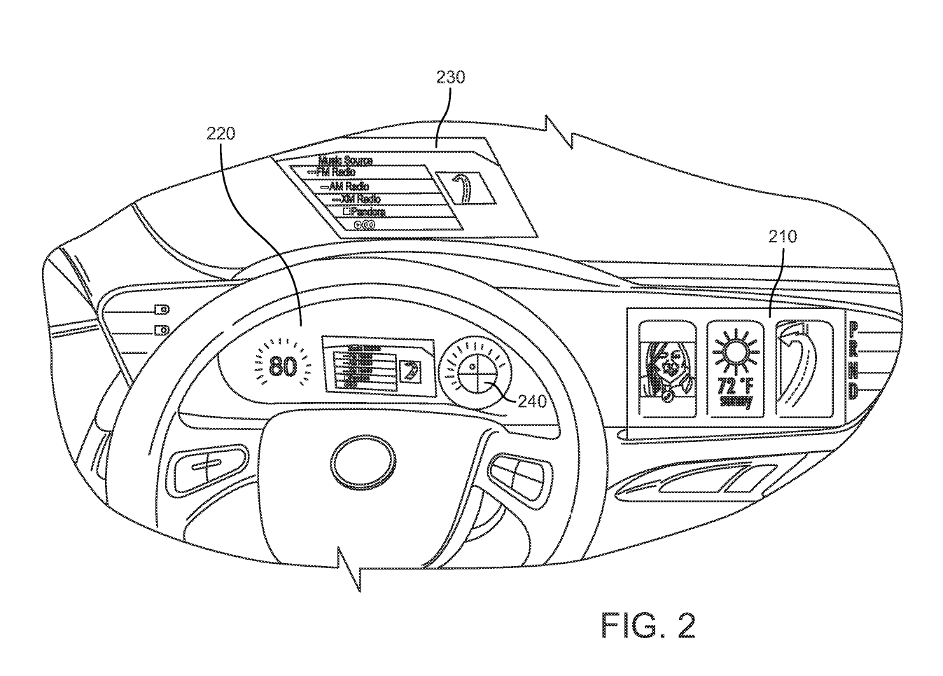

Referring to FIG. 2, an exemplary vehicle (an automobile) includes three displays. The vehicle may include an instrument cluster 220. The instrument cluster 220 may include analog instruments, digital instruments, or a combination of both analog and digital instruments. In some embodiments, the instrument cluster 220 includes only digital instruments. For example, the instrument cluster 220 may be a single display used for displaying one or more digital instruments to a vehicle occupant. Digital instruments may be nested within analog instruments. Analog instruments may be nested within digital instruments. In some embodiments, each digital instrument is displayed using a different display. In other embodiments, one or more digital instruments may be displayed on a single display. Multiple displays may be used within the instrument cluster 220.

Analog instruments may be instruments with components which mechanically move or change to convey information to a vehicle occupant. For example, a gauge (e.g., speedometer) may include a physical needle which moves relative to unit markings. Digital instruments may be instruments which are represented partially or entirely on a display using graphics and/or computing hardware to render and display an image of the gauge. For example, a speedometer may be represented as a digital instrument with a needle and unit markings rendered as digital graphics (e.g., in a frame buffer of memory) and displayed using a display (e.g., a liquid crystal display). A digital instrument may not include moving or mechanical parts. In some embodiments, an instrument may be a hybrid of digital instruments and analog instruments. For example, a speedometer may have a mechanical needle which moves to indicate speed with unit markings displayed on a display (e.g., to allow for switching between units such as miles per hour and kilometers per hour). Hybrid instruments may be considered to be digital instruments.

In one embodiment, the instrument cluster 220 and/or another display includes a friction bubble gauge 240. The friction bubble gauge 240 is a digital instrument. In other embodiments, the friction bubble gauge 240 is an analog instrument. The friction bubble gauge 240 may display information to a vehicle occupant about the acceleration of the vehicle. For example, the friction bubble gauge 240 may illustrate acceleration of the vehicle along the path of travel (e.g., due to straight line acceleration or braking) by moving an indicator bubble vertically in the friction bubble gauge 240. Lateral acceleration of the vehicle (e.g., do to turning or other left/right movement) by be illustrated by the friction bubble gauge 240 by displaying the indicator bubble along the horizontal axis (e.g., moving the indicator bubble left and right).

The fiction bubble gauge 240 may be nested within an analog or digital instrument. For example, the friction bubble gauge 240 may be nested within a digital tachometer. In other embodiments, the friction bubble gauge 240 is nested within an analog tachometer. The friction bubble gauge 240 may be nested in other gauges (e.g., a speedometer, temperature gauge, fuel gauge, etc.). Advantageously, nesting the friction bubble 240 within another gauge may more efficiently use a limited amount of space for displaying information to a vehicle occupant. For example, an instrument cluster 220 may be a defined and limited space, and nesting the friction bubble gauge 240 within another instrument may provide a vehicle occupant with additional information (e.g., from the friction bubble gauge 240) without requiring a larger instrument cluster 220. For example, the space within an instrument (e.g., tachometer) may be unused space (e.g., space with no information, space in which a gauge needle is depicted originating from the center of the instrument, etc.). Nesting an additional instrument such as a friction bubble gauge 240 within the instrument such that it takes up this unused space may provide an advantage in that additional information is provided to a vehicle occupant without requiring a larger instrument cluster 220. The information provided by the instrument in which another instrument is nested may be unobstructed as a portion of the gauge needle or other indicator may still be visible around the periphery of the nested instrument. This portion of the needle may indicate information to the vehicle occupant by pointing to markings on the outer edge of the instrument in which is nested the additional instrument.

In some embodiments, a vehicle includes one or more heads-up displays (HUDs) 230. HUD 230 may include components such as a protection unit, combiner, optical collimator, video generation computer, and/or other components. In some embodiments, one or more components of HUD 230 are shared with other systems of the vehicle or digital instrument system. For example, a windshield of the vehicle may also function as a combiner. The functions of the video generation computer may be performed in whole or in part by hardware used in the generation and/or display of digital instruments. For example, a processor, memory, graphics processing hardware, and/or other software or hardware may be used to generate the graphics for both digital instruments and for projection by a projector unit of HUD 230. A display controlled by the digital instrument system described herein may function as a projector unit for one or more HUDs 230. Digital instruments may be displayed on a HUD 230 using the digital instrument system described herein. Other techniques and/or hardware may be used to create HUD 230. For example, HUD 230 may be implemented using an optical waveguide or scanning laser.

In some embodiments, the vehicle may include one or more center counsel displays 210. Center counsel displays 210 may be or be part of a vehicle infotainment system. In some embodiments, center counsel display 210 is controlled by a digital instrument system such as the one described herein. Digital instruments may be displayed on the center counsel display 210. Images may be displayed on the center counsel display 210 by the digital instrument display system. Images may not be limited to digital instruments. For example, the center counsel display 210 may be used to display other information such as vehicle telematics information, weather information, navigation information, application output, and/or other images. The computation hardware (e.g., processor(s), memory, etc.) described herein as part of the digital instrument system may be used to display both digital instruments and other information such as that described above. In alternative embodiments, a vehicle infotainment system may use additional hardware other than the hardware related to the digital instrument system in whole or in part to display images on the center counsel display 210. Additional hardware may also be used for other functions associated with an infotainment system such as running applications, handling user input (e.g., center counsel display 210 may be a touch sensitive display such as a touchscreen), communication functions (e.g., controlling a wireless transceiver), and/or other functions. In further embodiments, hardware of a digital instrument system and hardware of an infotainment system may share components and/or otherwise be in communication. For example, a single processor or group of processors may be used for displaying images and/or digital instruments on one or more displays (e.g., instrument cluster 220 and center counsel display 210). The digital instrument system may use hardware associated with the center counsel display 210 in order to display digital instruments on center counsel display 210. For example, the digital instrument system may provide images (e.g., through frame buffers) to a control circuit of the center counsel display (e.g., used for handling inputs, running applications, displaying images, etc.) which in turn causes the images to be displayed on the center counsel display 210. The images may be of frames corresponding to a digital instrument (e.g., a friction bubble gauge 240).

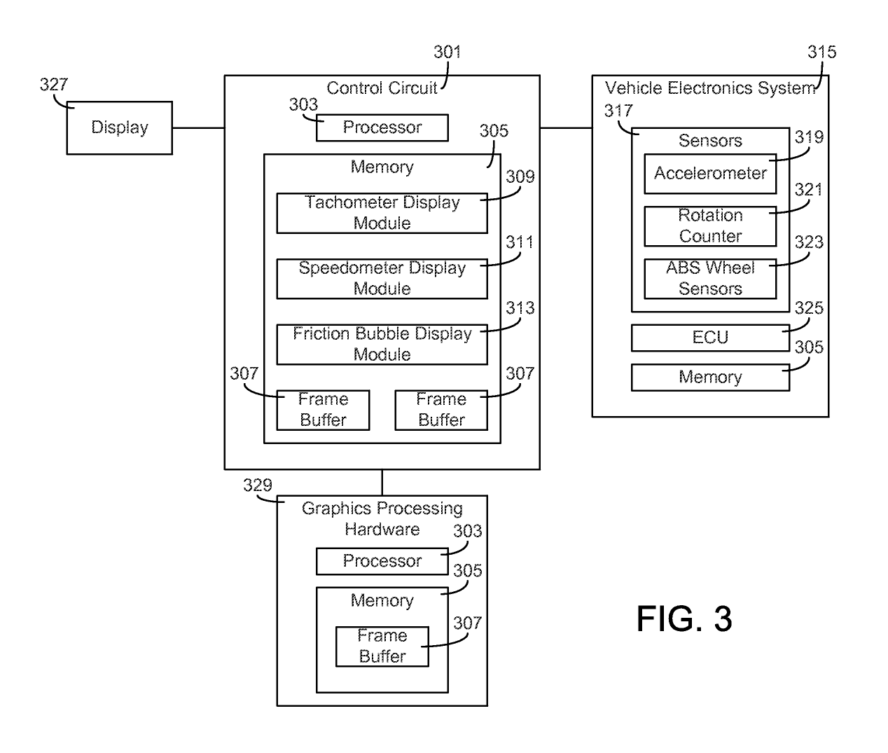

Referring now to FIG. 3, a block diagram illustrates the hardware components of a digital instrument system according to an exemplary embodiment. The digital instrument system may include a control circuit 301. The control circuit 301 may contain circuitry, hardware, and/or software for facilitating and/or performing the functions described herein. The control circuit 301 may handle inputs, process inputs, run programs, handle instructions, route information, control memory 305, control a processor 303, process data, generate outputs, communicate with other devices or hardware, and/or otherwise perform general or specific computing tasks. In some embodiments, the control circuit includes a processor 303. In some embodiments, the control circuit includes memory 305.

Processor 303 may be implemented as a general-purpose processor, an application specific integrated circuit (ASIC), one or more field programmable gate arrays (FPGAs), a digital-signal-processor (DSP), a group of processing components (e.g., a multicore processor or series of processors), or other suitable electronic processing components. Memory 305 is one or more devices (e.g. RAM, ROM, Flash Memory, hard disk storage, etc.) for storing data and/or computer code for facilitating the various processes described herein. Memory 305 may be or include non-transient volatile memory or non-volatile memory. Memory 305 may include database components, object code components, script components, or any other type of information structure for supporting various activities and information structures described herein. Memory 305 may be communicably connected to processor 303 and provide computer code or instructions to processor 303 for executing the processes described herein. Memory 305, processor 303, and/or the control circuit 301 may facilitate the functions described herein using one or more programming techniques, data manipulation techniques, and/or processing techniques such as using algorithms, routines, lookup tables, arrays, searching, databases, comparisons, instructions, etc.

In some embodiments, control circuit 301 is coupled to vehicle electronics system 315. Control circuit 301 and vehicle electronics system 315 may be in communication which allows the transfer of data between the vehicle electronics system and control circuit 301. This communication may be unidirectional with the control circuit 301 receiving information from the vehicle electronics system 315. For example, control circuit 301 may receive information related to the vehicle such as sensor data from vehicle electronics system 315. In other embodiments, communication between control circuit 301 and vehicle electronics system 315 is bi-directional. For example, control circuit 301 may send a request for information related to the vehicle to vehicle electronics system 315 which vehicle electronics system 315 handles and returns information (e.g., sensor data) to control circuit 301. The connection between control circuit 301 and the vehicle electronics system 315 may be made using a vehicle electronics system 315 interface included in the control circuit 301. In some embodiments, the vehicle electronics system interface includes physical connections such as ports, connectors, wiring, and/or other hardware used to create an electrical connection between the control circuit 301 and the vehicle electronics system 315. In alternative embodiments, the control circuit 301 and the vehicle electronics system 315 are directly connected (e.g., wired such that outputs from one control circuit are received as inputs at the other control circuit and/or vice versa). In further embodiments, the vehicle electronics system interface may include and/or be implemented by computer programming, code, instructions, or other software stored in memory 305 of control circuit 301.

Vehicle electronics system 315 may be or include a network of electrical components including processors (e.g., electronic control units (ECU) 325, engine control modules (ECM), or other vehicle processors), memory, buses (e.g., controller area network (CAN) bus, sensors 317, on-board diagnostics equipment (e.g., following the (OBD)-II standard or other protocol), cameras, displays, transceivers, infotainment systems, and/or other components integrated with a vehicle's electronics systems or otherwise networked (e.g., a controller area network of vehicle components). For example, the vehicle electronics system 315 may include, be coupled to, and/or otherwise communicate with a global positioning system (GPS) transceiver configured to receive position information (e.g., from a GPS satellite source). Using the vehicle electronics system, vehicle electronics system interface, and/or control circuit, the trainable transceiver may have access to position information from the GPS interface (e.g., GPS coordinates corresponding to the current location of the vehicle).

The vehicle electronics system 315 may perform additional functions. For example, the vehicle electronics system 315 may receive, process, and/or otherwise handle user inputs. User inputs may be received through controls such as buttons switches knobs, a touchscreen infotainment system, and/or other user input devices. Vehicle electronics system 315 may handle user inputs by controlling hardware components of the vehicle in response to the user input. The vehicle electronics system 315 may pass user input to control circuit 301.

In some embodiments, displays such as displays included in an instrument cluster 220, center counsel display 210, or HUD 230 may be controlled by one or more components of vehicle electronics system 315. This may include generating images for digital instruments and the display of digital instruments. In other embodiments, displays are controlled by the control circuit 301 and/or other hardware of the digital instrument system described herein. In further embodiments, the components of the digital instruments system form part of a vehicle electronics system. For example, the components of the digital instrument system may be networked with other vehicle components through a CAN included in the vehicle.

As described above, vehicle electronics system 315 may be a source of information related to the vehicle, user inputs, and or other data accessible by control circuit 301 of the digital instrument system. Information related to the vehicle may be provided by one or more sensors 317. Sensors 317 may measure information related to the vehicle. Sensors 317 may include air-fuel ratio meters, crankshaft position sensor, engine coolant temperature sensors, mass flow sensor, oxygen sensors, throttle position sensor, tire-pressure sensors, torque transducers, transmission fluid temperature sensors, wheel speed sensors, hall effect sensors, eddy current speedometer sensors, and/or other vehicle sensors for generating information or data related to a vehicle. As discussed above, the digital instrument system is not limited to land based vehicles. As such, the above presented partial list of sensors 317 which may be included in a vehicle is exemplary only. Additional and/or other sensors 317 may be included with a vehicle.

In some embodiments, vehicle electronics system 315 includes one or more accelerometers 319. Accelerometer 319 may be used to measure the acceleration of the vehicle. In one embodiment, accelerometer 319 measures acceleration in two dimensions. Accelerometer 319 measures acceleration along the axis of vehicle travel and lateral acceleration along the axis transverse to the direction of vehicle travel. For example, accelerometer 319 may measure acceleration along (e.g., parallel to) the roll axis of the vehicle and along the pitch axis of the vehicle. This allows the accelerometer to measure acceleration of the vehicle due to acceleration, braking, left movement of the car (e.g., due to turning), and/or right movement of the car (e.g., due to turning). In other embodiments, accelerometer(s) 319 measure more or fewer degrees of acceleration. For example, accelerometer 319 may measure acceleration along three axis (e.g., along the pitch, roll, and yaw axes). Alternatively, accelerometer 319 may measure acceleration along a single axis (e.g., along the roll axis to measure vehicle acceleration and braking). Accelerometer 319 may be a single-axis or multi-axis device such as a micro electromechanical system (MEMs) device. Accelerometer 319 may be or include other types of acceleration sensors or hardware configured to measure acceleration.

In some embodiments, vehicle electronics system 315 includes one or more rotation counters 321. Rotation counter 321 may be used to count the number of rotations on an engine crankshaft. Alternatively, rotation counter 321 may be configured to determine the frequency with which the crankshaft rotates. Rotation counter 321 may be used to measure engine rotations per minute (RPMs) for the vehicle (e.g., based on counted rotations per time period and/or frequency of rotation). Other sensors may be used in addition to or in place of a rotation counter 231 to measure engine RPM (e.g., a crankshaft position sensor such as a hall effect sensor, optical sensor, or inductive sensor may be used to determine engine RPM).

In some embodiments, vehicle electronics system 315 includes one or more anti-lock braking system (ABS) wheel sensors 323. ABS wheel sensors 323 may measure wheel speed for use in an ABS. The wheel speed measured for use in an ABS may be used to determine the speed of the vehicle (e.g., using the dimensions of the wheel and the rate of wheel rotation). ABS wheel sensors 323 may be or include wheel speed sensors (e.g., inductive sensors, optical sensors, hall effect sensors, rotation counters, and/or other sensors configured to determine rotational speed based on frequency of rotation and/or number of counted rotations for a given time period). Alternatively, vehicle speed may be determined using other sensors and/or techniques. For example, a rotation sensor may determine the frequency with which a drive shaft of the vehicle is rotating. This information may be used to determine the speed of the vehicle.

In some embodiments, one or more sensors 317 may output information related to the vehicle. For example, a vehicle speed sensor may output the speed of the vehicle (e.g., in miles per hour). Sensors 317 may output information related to the vehicle as digital information that has been processed to determine information related to the vehicle by the sensor 317 itself. In alternative embodiments, sensors 317 may output sensor data rather than information related to the vehicle. The sensor data may be processed (e.g., by one or more components of a vehicle electronics system 315 or control circuit 301) to determine information related to the vehicle based on the sensor output.

In alternative embodiments, information related to the vehicle may be information which is determined by vehicle electronics system 315 or control circuit 301 based on output from one or more sensors 317. For example, sensor output may be voltage, resistance, current, impedance, or other electrical values. The change in the electrical properties of the sensor may be used to determine information related to the vehicle. For example, change in voltage from a wheel speed sensor may be used to determine acceleration. The instant value of the electrical properties of the sensor may also be used to determine information related to the vehicle. For example, the voltage measured from an accelerometer may be used to determine the instant acceleration of the vehicle.

Vehicle electronics system 315 may use one or more ECUs 325 or other processors and memory 305 to process data or output from one or more sensors 315. Processing data from one or more sensors may be used to generate information related to the vehicle. For example, the vehicle electronics system may determine engine RPM based on information from a rotation counter 321 over a period of time. Output from ABS wheel sensors 323 may be used by vehicle electronics system 315 to determine the speed of the vehicle (e.g., by determining the distance travel per a set amount of time based on the counted number of wheel rotations during that amount of time and the dimensions of the vehicle wheels). Other information related to the vehicle may be determined by vehicle electronics system 315 based on data from sensors 317 and/or other information. For example, the vehicle electronics system 315 may determine the acceleration of the vehicle using an accelerometer 319 and/or other sensors 317 of vehicle electronics system 315. Other sensors 317 and/or analysis techniques may be used to determine information related to the vehicle. Information related to the vehicle may include the speed of the vehicle, engine RPMs, position or location of the vehicle, engine coolant temperature, engine oil temperature, engine oil pressure, battery voltage, tire pressure, transmission fluid temperature, remaining fuel, distance traveled, and/or other information related to the vehicle.

Vehicle electronics system 315 may also receive output from control circuit 301. Vehicle electronics system 315 may handle output (e.g., information, data, instructions, control signals, etc.) from control circuit 301. For example, control circuit 301 may output a request for sensor data, information related to the vehicle, and/or other information to vehicle electronics system 315. Vehicle electronics system 315 may receive the output from control circuit 301 and provide the requested information to control circuit 301 in response.

In some embodiments, the digital instrument system includes one or more displays 327. Displays 327 may be or may be part of instrument cluster 220, HUD 230, and/or center counsel display 210. In some embodiments, two or more displays 327 may be incorporated into a single instrument cluster 220, HUD 230, or center counsel display 210. For example, one digital instrument may be displayed on a display 327 in an instrument cluster 220 with a second digital instrument displayed on a second display 327 in the instrument cluster 220. In other embodiments, one display 327 is used. For example, all digital instruments are displayed on a single display 220 included in instrument cluster 220.

Display 327 allows for visual communication with a user. The display 327 may be configured to output a visual representation based on computer instructions, control signals, computer code, frame buffers, and/or other electronic signals or information. In some embodiments, the display includes a graphics processing unit (GPU), controller, analog to digital converter, digital to analog converter, and/or other hardware to facilitate the handling of and display of graphics information. For example, display 327 may include an integrated controller which causes display 327 to display an image based on information from a frame buffer in communication with the controller. In other embodiments, the display 327 does not include hardware for processing images or image data. The display 327 may be any hardware configured to display images using the emission of light or another technique. For example, the display 327 may be a liquid crystal display, e-ink display, plasma display, light emitting diode (LED) display, cathode ray tube display, laser display, and/or other display device. In some embodiments, the display 327 may be part of or otherwise integrated with a user input device such as a touchscreen display (e.g., projected capacitance touchscreen, resistance based touchscreen, and/or touchscreen based on other touch sensing technology). The display 327 be a touchscreen display.

Display 327 may be used to display information to a user which includes or is based on information related to the vehicle. For example, display 327 may display the speed of the vehicle, engine RPMs, acceleration of the vehicle due to straight line and/or lateral travel, and/or other information. Information displayed to the user may include information related to vehicle kinematics, engine performance, vehicle behavior and/or other information. Information may be displayed in the form of a digital instrument as described herein or other digital instrument. The display of this information may be in response to the values in a frame buffer generated by control circuit 301 and/or memory 305 (e.g., according to a module for displaying information via one or more digital instruments). Display 327 may also display other information such as infotainment information, navigation information, communications information, and/or other information. A single display 327 may display both types of information. In other embodiments, one display 327 is dedicated to information related to the vehicle or information based thereon and a second display 327 is dedicated to other information. In further embodiments, a plurality of dedicated displays may be used for each information type.

Control circuit 301 may include one or more frame buffers 307. Frame buffer 307 may store image information (e.g., the color value or other characteristic of the pixels of a display 327). Frame buffer 307 may be implemented using memory 305. A virtual frame buffer may be used. In some embodiments, frame buffer 307 may be standalone memory not included within other memory 305. Image information may be used by a display controller to display an image on display 327 as described above. The controller may read the frame buffer 307 to determine the pixel value (e.g., on or off status, color, etc.) and cause the display to respond based on the information in the frame buffer 307. In some embodiments, frame buffer 307 is contained within memory 305 of control circuit 301. The position (e.g., address) of the frame buffer 307 in memory 305 may be provided to the display 327 by control circuit 301. In other embodiments, frame buffer 307 may be standalone memory not included within memory 305 of control circuit 301 (e.g., memory used for programs, instructions, modules, and/or other information). In some embodiments, control circuit 301 includes a frame buffer 307 for each display 327 controlled by the control circuit 301. For example, control circuit 301 may include three frame buffers 307 with frame buffer 307 corresponding to a display 327 included in instrument cluster 220, HUD 230, and center counsel display 210. In further embodiments, one or more frame buffers 307 corresponding to the displays 327 of a vehicle are included in vehicle electronics system 315. Frame buffer 307 may be filled by control circuit 301.

Control circuit 301 and/or one or more modules in memory 305 may be used to fill frame buffer 307 according to the techniques described herein for generating a digital instrument. Frame buffer 307 may be filled so as to cause the display of both digital instruments and other images (e.g., images related to an infotainment system). In some embodiments, frame buffer 307 is filled by graphics processing hardware 329. Frame buffer 307 may also be filled by one or more components of vehicle electronics system 315 in some embodiments. In alternative embodiments, one or more frame buffers 307, used in displaying images on one or more displays 327, are filled only by graphics processing hardware 329.

In alternative embodiments, displays 327 display information based on the values of a frame buffer(s) 307 included in graphics processing hardware 329. The frame buffer of graphics processing hardware 329 may replace or augment frame buffers 307 included with other components (e.g., control circuit 301). For example, a controller of a display 327 may read a frame buffer 307 in graphics processing hardware 329 rather than a frame buffer in 307 in control circuit 301. Control circuit 301 may not contain a frame buffer 307.

Alternatively, the frame buffer 307 of graphics processing hardware 329 may be used to fill a frame buffer 307 of control circuit 301. The frame buffer of control circuit 301 may be used to control the output of a display 327. Multiple frame buffers 307 of control circuit 301 may be filled in this manner. Alternatively, graphics processing hardware 329 or a portion thereof may be dedicated to a single display 327. For example, graphics processing hardware 329 may be used to generate frame buffer 307 values for instrument cluster 220 (e.g., corresponding to digital instruments). The images may be stored in frame buffer 307 of graphics processing hardware 329 and transferred to a second frame buffer 307 in control circuit 301 for display using a display 327 of instrument cluster 220. A third and/or additional frame buffers 307 of control circuit 301 may be filled by other hardware and or software (e.g., control circuit 301, vehicle electronics system 315, etc.) and used to display images on other displays 327 (e.g., displays 327 associated with HUD 230, center counsel display 220, etc.). In some embodiments as described above, a display 327 or multiple displays may be controlled or driven based on one or more frame buffers 307 of graphics processing hardware 329.

Graphics processing hardware 329 may be used to render and/or otherwise generate images (e.g., bitmaps) for display. Graphics processing hardware 329 may be used to fill one or more frame buffers 307. Graphics processing hardware 329 may operate according to instructions, data, or other information or commands received from control circuit 301 and/or memory 305 of control circuit 301 (e.g., from programs running according to one or more modules in memory 305). Graphics processing hardware 329 provides hardware acceleration to the functions associated with displaying images on one or more displays 327. Advantageously, this may increase the performance of one or more digital instruments (e.g., reduce the latency of the digital instrument). In some embodiments, graphics processing hardware 329 is included in control circuit 301. In other embodiments, graphics processing hardware may be separate components in communication with control circuit 301 (e.g., as illustrated). In alternative embodiments, the functions of graphics processing hardware described herein are carried out by control circuit 301 and additional graphics processing hardware 329 is not included in the digital instrument system.

Graphics processing hardware 329 may be hardware dedicated to producing (e.g., rendering) graphics and filling one or more frame buffers 307.

Graphics processing hardware 329 may include one or more processors 303. Graphics processing hardware may include memory 305. Memory 305 may be or include a frame buffer 307. Memory 305 may contain instructions, programs, computer code, and/or other information used in performing the functions of graphics processing hardware 329. Graphics processing hardware 329 may be configured to receive commands, instructions, data, and/or other information from control circuit 301. Graphics processing hardware 329 may generate images (e.g., fill a frame buffer 307) based on information or instructions from control circuit 301. Graphics processing hardware 329 may perform functions such as rendering, creating images, texture mapping, shading, compositing, performing bitwise operations, handling image masks, handling image backgrounds, performing raster operations, alpha compositing, and/or other functions related to the generation or manipulation of images. Graphics processing hardware 329 may provide hardware acceleration of function related to image generation and/or manipulation. Graphics processing hardware 329 may include hardware and/or software specialized for providing hardware acceleration of functions related to image generation and/or manipulation. For example, graphics processing hardware 329 may be or include a graphics processing unit (GPU), shader, compositor, blitter, and/or other hardware. Graphics processing hardware 329 may include software to support the function of hardware components (e.g., a GPU, shader, compositor, and/or other hardware). The hardware and/or software of graphics processing hardware 329 may be used to generate and/or manipulate one or more digital instruments and/or other images (e.g., infotainment images) for a vehicle.

In further embodiments, graphics processing hardware may be used to implement a single digital instrument. One set of graphics processing hardware 329 may be used for a first digital instrument. A second set may be used for a second digital instrument. Alternatively, some sets of graphics processing hardware 329 may be used for individual digital instruments while other sets are used to for multiple images. For example, graphics processing hardware 329 may be used to produce a bitmap in a frame buffer corresponding to a friction bubble digital instrument. Other graphics processing hardware 329 and/or control circuit 301 may be used to produce a bitmap for other digital instruments (e.g., tachometer and speedometer). In other words, graphics processing hardware 329 may be grouped such that some digital instruments are generated (e.g., rendered and stored in a frame buffer 307) using code based techniques while other digital instruments are generated on separate graphics processing hardware 329 using hardware acceleration and pre-rendered image assets. These techniques are discussed in greater detail in later sections herein.

An application programming interface (API) may be used by the control circuit 301 and/or memory 305 (e.g., a program or module stored in memory and executed by control circuit 301) to control the interaction between software components (e.g., programs or modules stored in memory 305) and the graphics processing hardware 329. For example, the API may be OpenGL. The API may be used by the control circuit 301 and/or programs running thereon (e.g., stored in memory 305 as modules) to provide instructions and/or data to graphics processing hardware 329. Control circuit 301 and/or programs running thereon may use graphics processing hardware 329 to generate images (e.g., bitmaps) which are displayed using one or more displays 327 (e.g., the images may be stored in a frame buffer 307 which a display controller uses to cause the display of an image). The control circuit 301 may cause graphics processing hardware 329 to render images, manipulate pre-rendered graphics assets, generate bitmaps, and/or otherwise generate images and/or fill a frame buffer 307. Images may be generated based in part or in whole on information related to the vehicle from vehicle electronics system and/or programs or other instructions stored in memory 305 (e.g., modules) and executed by control circuit 301.

Memory 305 of control circuit 301 may contain one or more modules. Modules are stored in memory 305 contained on control circuit 301. The modules include instructions for operating the digital instrument system. In some embodiments, modules also include instructions for operating other image based systems of a vehicle (e.g., an infotainment system). Such modules are shown to include: tachometer display module 309, speedometer display module 311, and friction bubble display module 313. Modules may further include modules not illustrated but corresponding to other digital instruments. Modules may also include modules for displaying images, processing inputs, controlling the digital instrument system and/or other systems of the vehicle, performing general computing functions, and/or performing other functions related to the digital instrument system and/or other vehicle systems. Multiple modules may be used together.

Modules may be used for the display of one or more digital instruments. For example, tachometer display module 309 may be used to display a tachometer, speedometer display module 311 may be used to display a speedometer, and friction bubble display module 313 may be used to display a friction bubble gauge 240. Modules may contain instructions (e.g., computer code) for receiving information related to the vehicle from vehicle electronics system 315. Modules may also contain instructions for manipulating the information received from the vehicle electronics system 315. Instructions (e.g., computer code) included in the modules may be executed or otherwise carried out by control circuit 301 (e.g., using processor 303 to perform calculations or other tasks).

For example, tachometer display module 309 may include instructions to retrieve and/or receiver from vehicle electronics system 315 the frequency of rotation of the crankshaft (e.g., based on a hall effect sensor). The tachometer display module 309 may include instructions which cause the control circuit 301 to determine engine RPMs based on the frequency of rotation (e.g., using a lookup table of rotation frequencies and corresponding RPM values). Tachometer display module 309 may further include instructions and/or information which cause the graphics processing hardware 329 to fill a frame buffer 307 with an image of a digital instrument showing the determined RPM value (e.g., an image of a tachometer with the needle pointing to the determined RPM value).

Continuing the example, speedometer display module 311 may include instructions to retrieve and/or receive from vehicle electronics system 315 information form a wheel rotation counter. Using information from a wheel rotation counter (e.g., the number of rotations counted) over a given time and the geometry of the wheels and/or tires, the speed of the vehicle may be determined according to instructions in speedometer display module 311 (e.g., control circuit 301, according to instructions in speedometer display module 311, may determine the rotational velocity of the wheel using the number of rotations over a known time period, determine the distance traveled by the vehicle for that time period using the geometry of the wheel, and divide the distance traveled by the time period to find the velocity or speed of the vehicle).

Memory 305 may include a friction bubble display module 313. Friction bubble display module 311 may include instructions to retrieve and/or receive information from vehicle electronics system 315. The information related to the vehicle which is received from vehicle electronics system 315 may be used to determine the acceleration of the vehicle. In one embodiment, accelerometer voltage (e.g., as output by accelerometer 319) is received from vehicle electronics system 315 and used to determine the acceleration of the vehicle. For example, an algorithm, lookup table, or other analysis technique may be used to determine the acceleration of the vehicle corresponding to a voltage output by the accelerometer 319. Other techniques may be used to determine the acceleration of the vehicle. For example, acceleration may be determined based on velocity information (e.g., taking the derivative of velocity data over a period of time). Based on the determined acceleration of the vehicle, instructions may be provided to graphics processing hardware 329 for producing an image of the friction bubble gauge 240 which displays the acceleration of the vehicle to a vehicle occupant on display 327.

The above described hardware and software components of a digital instrument system may be used to facilitate, cause, or otherwise aid in performing or perform the functions described herein. As described above, multiple combinations of hardware and/or software may be used to perform the functions described herein. The above hardware illustrations are exemplary only, and other combinations of, subsets of, and/or additional hardware to the hardware described above may be used in carry out the processing, graphics generation, and/or other functions of the digital instrument system and/or other systems described herein.

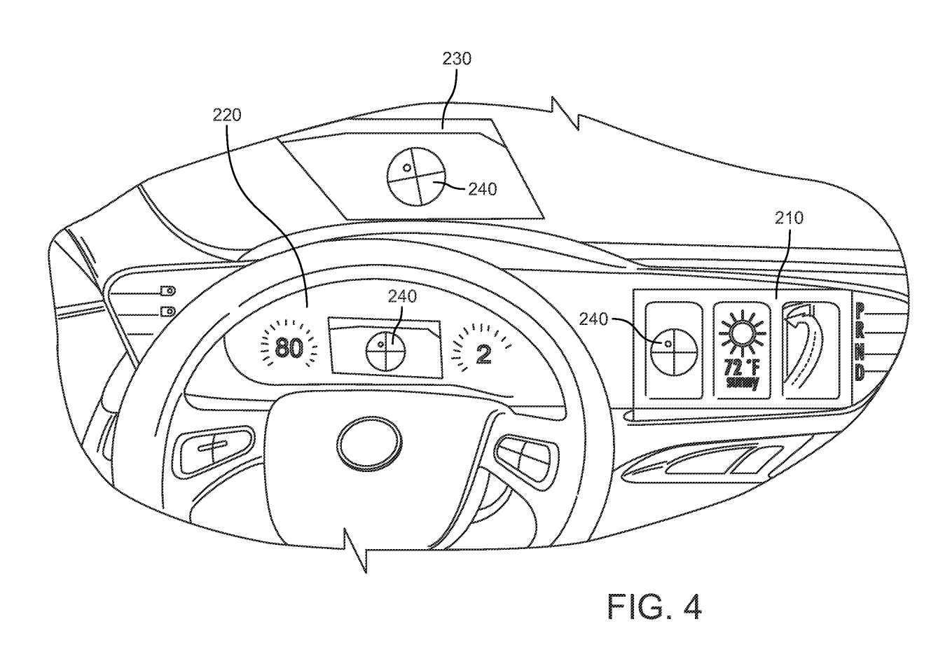

Now with reference to FIG. 4, a friction bubble gauge 240 may be displayed on one or more of instrument cluster 220, HUD 230, and/or center counsel display 210. In some embodiments, a user of the digital instrument system may customize one or more features of the display of digital instruments. A user may select which digital instruments are displayed on displays 327 associated with different locations (e.g., displays 327 incorporated in instrument cluster 220, HUD 230, and/or center counsel display 210). A user may provide input to a vehicle electronics system 315 to cause the display of one or more selected digital instruments on one or more displays 327. One or more components of the vehicle electronics system 315 may receive user input for customization of the display of digital instruments. For example, a user may select which digital instruments are displayed in which locations using an infotainment system implemented by a touch screen display 327 of center counsel display 210. The touchscreen may list available digital instruments, show display locations, and/or otherwise allow for the customization of digital instruments through a graphical user interface. The graphical user interface may include elements such as icons, gestures, fields, searches, buttons, menus, and/or other graphical user interface elements to support the customization functions discussed herein. Other input and/or customization techniques may be used (e.g., a user may rotate through available digital instruments for display in the instrument cluster 220 using a steering wheel mounted button until the user finds the desired digital instrument which then remains displayed on a display 327 included in the instrument cluster 220). In some embodiments, characteristics and or properties of digital instruments (e.g., size, content, layout, and/or other display characteristics) may be customized by a user as described herein using one or more of the user interface techniques described herein (e.g., using an infotainment touchscreen and user interface).

As discussed above, display 327 may be used to display information to a user which includes or is based on information related to the vehicle. For example, display 327 may display the speed of the vehicle, engine RPMs, acceleration of the vehicle due to straight line and/or lateral travel, and/or other information. Information displayed to the user may include information related to vehicle kinematics, engine performance, vehicle behavior and/or other information. Information may be displayed in the form of a digital instrument as described herein or other digital instrument. The display of this information may be in response to the values in a frame buffer generated by control circuit 301 and/or memory 305 (e.g., according to a module for displaying information via one or more digital instruments). Display 327 may also display other information such as infotainment information, navigation information, communications information, and/or other information.

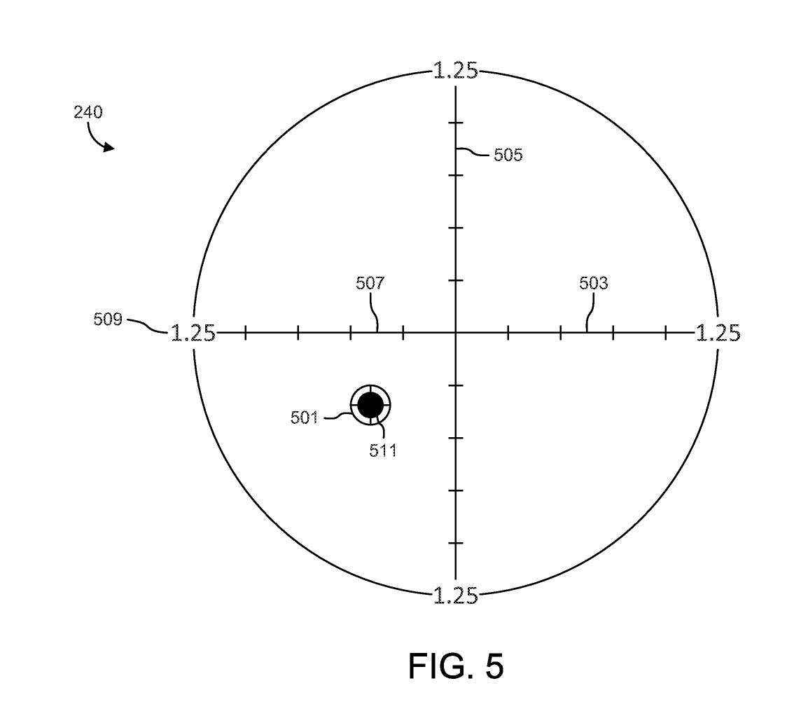

Referring now to FIG. 5, a friction bubble gauge 240 is illustrated according to one embodiment. Friction bubble gauge 240 may be a digital instrument displayed on a display 327.

The image displayed may be displayed based on one or more bitmaps or other information or images stored in a frame buffer 307 or memory 305. Friction bubble gauge 240 may include a bubble 501. The position of bubble 501 along the horizontal axis 503 and vertical axis 505 may indicates the acceleration of the vehicle to a vehicle occupant. Vertical axis 505 corresponds to acceleration and braking of the vehicle (e.g., acceleration, including deceleration) of the vehicle along the direction of travel of the vehicle). Horizontal axis 503 corresponds to lateral acceleration of the vehicle. The horizontal axis 503 and/or vertical axis 505 may include scale marks 507 to indicate the value of acceleration at that point on the axis. For example, each scale mark 507 may correspond to 0.25 g of acceleration. A g of acceleration may be the acceleration due to gravity at the surface of the earth. One g may be equivalent to 9.80665 meters per second per second. Friction bubble gauge 240 may include value labels 509. Value labels 509 may be the value of the unit of measure at a point along an axis. In some embodiments, only the maximum value of the axis is labeled with a value label 509 (e.g., 1.25 g as illustrated in FIG. 5). In other embodiments, multiple points may be labeled. Bubble 501 may have fill 511. Fill 511 may change colors with the intensity of the acceleration of the vehicle (e.g., absolute value or magnitude of the acceleration of the vehicle in any direction). Fill 511 may change colors according to one or more of the techniques described herein.

Acceleration may be displayed by friction bubble gauge 240 as positive acceleration in a certain direction. For example, friction bubble 240 may display acceleration of the vehicle in a straight line as positive forward acceleration (e.g., the top half of vertical axis 505). Deceleration of the vehicle (e.g., due to braking) may be illustrated as positive acceleration of the vehicle towards the rear of the vehicle (e.g., the lower half of vertical axis 505). In other embodiments, acceleration is shown as positive acceleration and negative acceleration (e.g., negative acceleration due to braking, or in other words, deceleration).

In other embodiments, one or more axis of friction bubble 240 may display the acceleration component of g force experienced by the vehicle. In other words, the acceleration displayed by friction bubble gauge 240 may have the opposite sign of the acceleration experienced by the vehicle. For example, a vehicle making a right hand turn may experience acceleration towards the center point of the turn. Rather than displaying this normal acceleration as acceleration towards the right (e.g., with the bubble 501 on the right half of horizontal axis 503), the acceleration displayed may be acceleration of the opposite sign (e.g., the bubble is on the left half of horizontal axis 503 during a right hand turn). This display may be more intuitive to a vehicle occupant who feels his or her body pushed to the left by a right hand turn. The friction bubble 501 moving to the left may appear to correspond to the motion of the vehicle occupant rather than normal acceleration. Using the opposite sign of the measured acceleration of the vehicle for displaying lateral acceleration may provide an advantage in that the friction bubble gauge 240 will be more intuitive to a vehicle occupant. It may be easier for a vehicle occupant to understand the kinematic behavior of the vehicle based on the motion of the bubble 501 due to lateral acceleration if the motion of the bubble 501 corresponds to the perceived motion of the user's own body during a turn of the vehicle (e.g., due to momentum of the vehicle occupant and the normal acceleration of vehicle). Therefore, the lateral acceleration, as indicated by the bubble 501 along the horizontal axis, may show the opposite acceleration of the vehicle (e.g., −g). In a right hand turn, the bubble 501 may move to the left. In a left hand turn the bubble may move to the right. This type of display technique may also be intuitive to a vehicle occupant as the vehicle will likely travel in the opposite direction of that of the turn if the vehicle losses traction. For example, a vehicle attempting to make a left hand turn that is too aggressive may lose traction and skid to the right. In other embodiments, the friction bubble gauge 240 displays the true acceleration of the vehicle to the vehicle occupant. Acceleration or the acceleration component of g force may be used as the unit of measure for the horizontal axis 501. Acceleration or the acceleration component of g force may be used as the unit of measure for the horizontal axis 503. Thus four combinations of display are possible with the axes using one or the two values.

In one embodiment, acceleration of the vehicle of the vehicle along the direction of travel (e.g., acceleration due to straight line acceleration or braking) is shown using the normal convention of acceleration. For example, as the vehicle accelerates (e.g., more throttle is applies) the bubble 501 will move into the top half of the vertical axis 505, and as the vehicle decelerates (e.g., due to braking) the bubble 501 will move into the bottom half of vertical axis 505. The horizontal axis 503 and bubble 501 illustrates the acceleration component of the g force experienced by the vehicle due to lateral acceleration (e.g., negative normal acceleration). For example, as the vehicle accelerates towards the right while turning right (e.g., normal acceleration) the opposite of the measured value is displayed such that the bubble 501 moves into the left half of the horizontal axis 501 to the position corresponding with the absolute value of the measured acceleration. As the vehicle accelerates towards the left while turning left (e.g., normal acceleration) the opposite of the measured value is displayed such that the bubble 501 moves into the right half of the horizontal axis 501 to the position corresponding with the absolute value of the measured acceleration. This embodiment may provide an advantage in that it may be the most intuitive combination of acceleration and the acceleration component of g force. A user may expect to see bubble 501 move up when the vehicle accelerates (strait line acceleration), move down when the vehicle brakes, move left when the vehicle turns right, and move right when the vehicle turns left. Thus, this embodiment may provide a friction bubble gauge 240 which is easy to read for a vehicle occupant and thus easily conveys information to the vehicle occupant about the acceleration of the vehicle.

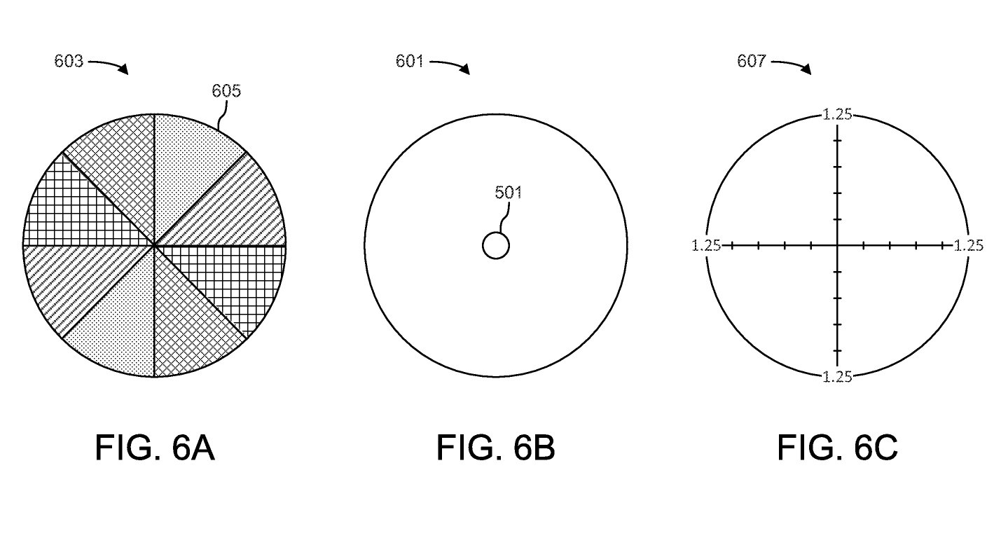

Referring now to FIGS. 6A-6C, the friction bubble gauge 240 (e.g., the image of the gauge stored in a frame buffer 307 for display) may be generated using pre-rendered graphics assets in one embodiment. The friction bubble gauge 240 may be generated using a bitmap mask 601 which reveals a portion of a color gradient bitmap background 603 based on the position of the bubble 501 and mask 601 relative to the color gradient bitmap background 603.

Referring now to FIG. 6A, a color gradient bitmap background 603 is illustrated according to one embodiment. The color gradient bitmap background may include one or more regions 605. Regions 605 may be different colors. The color gradient bitmap background may be a pre-rendered bitmap stored in memory 305 (e.g., memory 305 or control circuit 301 or memory 305 of graphics processing hardware 329). Information may be stored for each pixel of color gradient bitmap background 603 which correspond to the color value of each pixel. This information may be used by a controller to display an image of the color gradient bitmap background 603 or a portion thereof.

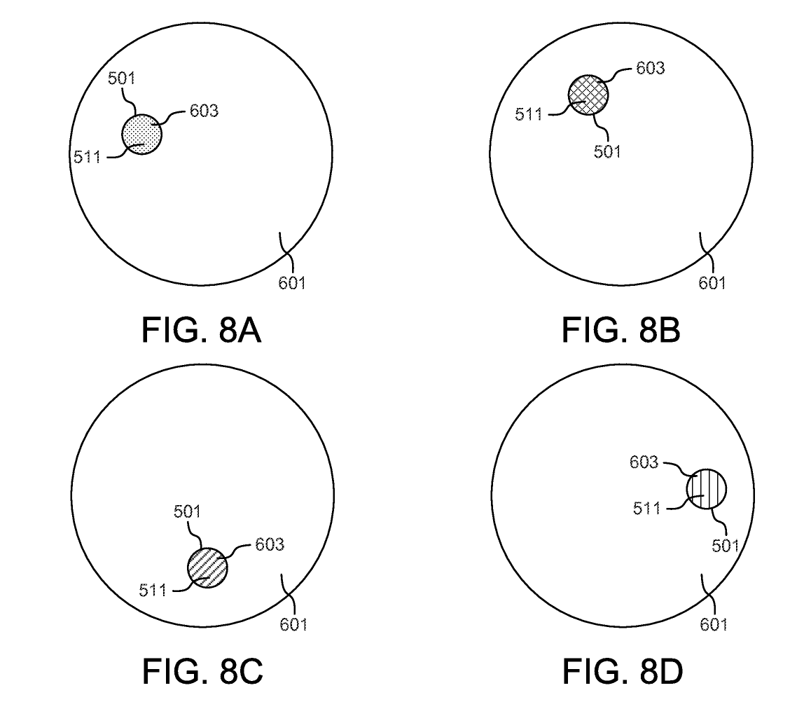

Referring now to FIG. 6B, a bitmap mask 601 is illustrated according to an exemplary embodiment. The bitmap mask 601 may include a bubble 501. In some embodiments, bitmap mask 601 is larger (e.g., includes more pixels) than color gradient bitmap background 603. This may allow for the bitmap mask to be translated (e.g., moved left, right, up, and/or down) relative to the color gradient bitmap background 603 such that the bubble 501 of mask 601 is positioned over a different area of color gradient bitmap background 603. In some embodiments, the value of the pixels corresponding to the portion of the bitmap mask 601 illustrated as bubble 501 have a bit value of 1. The remaining pixels of mask 601 may have a value of 0. This may allow for bitwise operations which combine the mask 601 and color gradient bitmap background 605 such that the portion of the color gradient bitmap background 603 and corresponding color(s) (e.g., due to the region 605) in the same area as bubble 501 are displayed while the remaining area of the color gradient bitmap background 603 are obscured by the mask 601 (e.g., pixels of mask 601 with a value of 0). This technique is explained in greater detail with reference to FIGS. 8A-10. The mask 601 may be a pre-rendered bitmap stored in memory 305 (e.g., memory 305 or control circuit 301 or memory 305 of graphics processing hardware 329).

In some embodiments, the friction bubble gauge 240 may include further elements such as axes and labels (e.g., the features described above with reference to FIG. 5). These additional elements may be part of a labels bitmap 607. Labels bitmap 607 may be pre-rendered and stored in memory (e.g., memory 305 or control circuit 301 or memory 305 of graphics processing hardware 329). Using bitwise operations, the image features (e.g., axes) illustrated by the labels bitmap 607 may be added to the friction bubble gauge 240 prior to display. For example, the color gradient background bitmap 603 and mask 601 may be used to generate a colored bubble 501 in the correct position (e.g., pixel coordinates) using bitwise operations. The mask 601 may reveal the color of the region 605 which is below (e.g., in the same pixel coordinates as) the bubble 501. Using bitwise operations, the features of labels bitmap 607 may be added to the bitmap having bubble 501 which reveals color from color gradient background bitmap 605 corresponding to the fill 511 of bubble 501 while leaving the remaining area of the bitmap black. This may result in pixel information stored in a frame buffer 307 including information for pixels from one or more of color gradient bitmap background 603, mask 601, and/or labels bitmap 607. When the frame buffer 307 is displayed (e.g., using a controller and display 327), an image of the friction bubble gauge 240 (e.g., as depicted in FIG. 5) may be provided to a vehicle occupant.

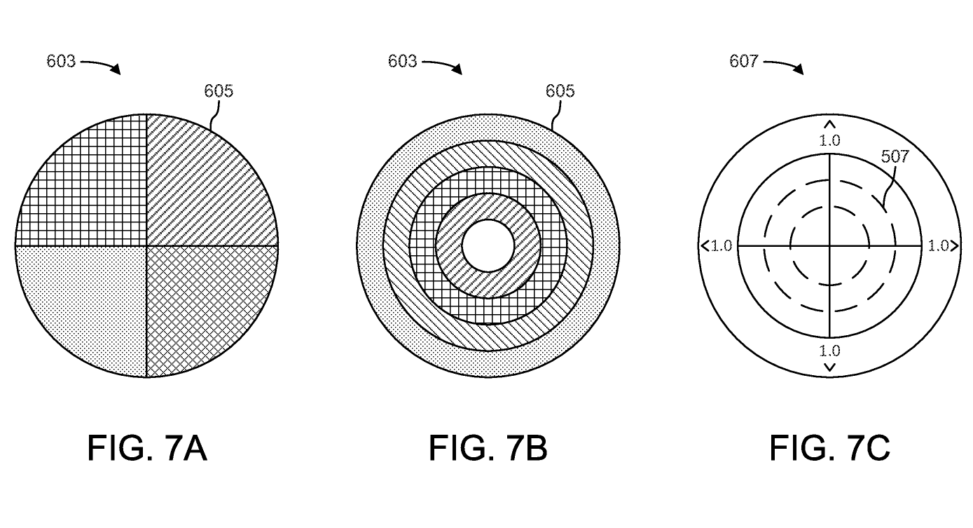

Referring now to FIGS. 7A-7C, alternative embodiments of the components of friction bubble gauge 240 are illustrated. With reference to FIG. 7A, the color gradient bitmap background 603 may be divided into four regions 605 each with a different color (e.g., red, blue, purple, and black). Each region 605 may correspond to one of four possible combinations of later and straight line acceleration. For example, regions may correspond to: braking and turning left, braking and turning right, accelerating (i.e., increasing velocity) and turning right, and accelerating (i.e., increasing velocity) and turning left). More or fewer wedge shaped regions may be used (e.g., as illustrated in FIG. 6A). Advantageously, the color of the bubble 501 and fill 511 may quickly indicate to a vehicle occupant in direction the vehicle is accelerating. For example, the bubble 501 may be blue if the vehicle is increasing straight line velocity and turning left and be red if the vehicle is increasing straight line velocity and turning right. This may provide an advantage in that the color of the bubble 501 may reinforce the information about the acceleration of the vehicle provided by the position of bubble 501 relative to the horizontal axis 503 and vertical axis 505. With two sources of information (color and position), friction bubble gauge 240 may better convey acceleration information to a vehicle occupant.

Referring now to FIG. 7B, regions 605 of color gradient bitmap background 603 are concentric rings in one embodiment. The concentric ring regions 605 may be centered on the center point of the color gradient bitmap background 603. As a bubble 501 is positioned further from the center point, the bubble 501 will reveal a different color. In some embodiments, each region coincides with a label (e.g., tick mark) indicating the value of acceleration at that position on the axis. Advantageously, a color gradient bitmap background 603 with concentric regions 605 of different colors may allow the bubble 501 of the friction bubble gauge 240 to indicate the magnitude of acceleration in any direction using color. For example, the first ring region 605 of color gradient bitmap background 603 may be green, the second ring from the center point may be yellow, the third orange, the forth red, the fifth purple, etc. As the vehicle experiences greater magnitudes of acceleration in any direction, the color revealed by bubble 501 will change according to the magnitude of the acceleration. A small amount of acceleration will result in a the bubble 501 being green, moderate acceleration yellow, hard acceleration red, and so on. Therefore the color of the bubble 501 of friction bubble gauge 240 is tied to the acceleration of the vehicle and may communicate the magnitude of acceleration to the vehicle occupant. This may provide an additional type of communication for providing the vehicle occupant with information about the magnitude of the acceleration experienced by the vehicle (e.g., color of bubble 501 and position of bubble 501 on the vertical axis 505 and/or horizontal axis 503). Using two types of communication may provide an advantage in that the vehicle occupant is more likely to easily read and understand the acceleration data provided by the friction bubble gauge 240.

Referring now to FIG. 7C, an embodiment labels bitmap 607 having additional scale marks 507 is illustrated. Labels bitmap 607 may have other labels and/or configurations. For example, labels bitmap 607 may include curved scale marks 507 as illustrated in FIG. 7C. Other label configurations are possible.

Referring generally to FIGS. 6A-11, the friction bubble gauge 240 is produced as a digital instrument using pre-rendered graphics assets and image generation (e.g., rendering techniques). The pre-rendered graphics assets are bitmap images (e.g., pixel data) stored in memory 305. The pre-rendered graphics assets may include mask 601, color gradient bitmap background 603, and/or labels bitmap 607. The acceleration of the vehicle is determined using one or more of the techniques described herein. Using the determined acceleration of the vehicle, the mask 601 is manipulated such that the bubble 501 portion of the mask 601 is positioned relative to the color gradient bitmap background 603 and/or labels bitmap 607 corresponding to the acceleration of the vehicle (e.g., during deceleration of the vehicle the bubble 501 is in the lower hemisphere of the fiction bubble gauge 240 and over the lower hemisphere of color gradient bitmap background 603). The position of bubble 501 of mask 601 corresponds to the acceleration of the vehicle. In one embodiment, mask 601 is manipulated to position bubble 501 by translating the entire mask 601 relative to color gradient bitmap background 603. The translation of the mask 601 may occur before the mask 601 is combined with the color gradient bitmap background 603. The graphic asset of the mask 601 may be stored with bubble 501 located at particular pixel coordinates. The entirety of the mask 601 may be shifted to new pixel coordinates based on the determined acceleration. As a result, the bubble 501 may be in a different position relative to the pixel coordinates of the mask 601 stored in memory prior to translation. The mask 601 and color gradient bitmap background 603 may share the same initial pixel coordinates such that the translated mask 601 results in bubble 501 moving relative to the shared pixel coordinate system and therefore relative to color gradient bitmap background 603 prior to the combination of mask 601 and color gradient bitmap background 603. Bubble 501 does not move relative to mask 601. Mask 601 including bubble 501 is translated. The translated mask 601 may then be combined with the color gradient bitmap background 603 as describe herein.

In other embodiments, the mask 601 is re-rendered in response to the determined acceleration. The pixel coordinates of the mask 601 may remain fixed. The bubble 501 may be repositioned relative to mask 601 in response to the determined acceleration of the vehicle. Bubble 501 moves relative to mask 601. The re-rendered mask 601 may then be combined with color gradient bitmap background 603 as described herein.

The color gradient bitmap background 603 and manipulated mask 601 (e.g., translated or re-rendered based on vehicle acceleration) may then be combined. The mask 601 reveals the portion of the color gradient bitmap background 603 corresponding to the location of bubble 501 of mask 601. This combination of the mask 601 and color gradient bitmap background may be made using bitwise operations which preserve the portion of the color gradient bitmap background 603 with the same pixel positions of the bitmap mask 601 while overwriting the remainder of the color gradient bitmap background 603 with the pixels of the mask 601 not included in the bubble 501. The color of the color gradient bitmap background 603 is preserved as fill 511 of bubble 501 of mask 601 while the remainder of the color gradient bitmap background 603 is overwritten with black pixels of the mask 601 making up the portion of the mask 601 which is not bubble 501.

The resulting bitmap following the bitwise operations may be combined with labels bitmap 607. The resulting bitmap (with or without the addition of labels bitmap 607) is then stored in one or more frame buffers 307. The bitmap stored in the frame buffer 307 is then displayed by a display 327 (e.g., using a controller).

The above described functions may be performed with hardware and/or software components such as those described with reference to FIG. 3. For example, the pre-rendered color gradient bitmap background 603, pre-rendered mask 601, and/or pre-rendered labels bitmap 607 may be stored in memory 305 of control circuit 301. In alternative embodiments, the pre-rendered graphics assets may be stored in memory 305 of graphics processing hardware 329. The acceleration of the vehicle may be determined by the control circuit 301 in response to information related to the vehicle received from vehicle electronics system 315 (e.g., using one or more of the techniques previously described herein). The control circuit 301 may prepare instructions for the graphics processing hardware 329 based on the determined acceleration (e.g., using friction bubble display module 313). For example, control circuit 301 may prepare instructions which cause graphics processing hardware 329 to translate the bitmap mask 601 vertically and/or horizontally by fixed amounts based on the acceleration of the vehicle (e.g., based on the processed information related to the vehicle received from the vehicle electronics system 315). Alternatively, the instructions may cause the graphics processing hardware 329 to re-render the bitmap mask 601 with bubble 501 repositioned relative to the bitmap mask 601.

The control circuit 301 may send the instructions to graphics processing hardware 329. In alternative embodiments, graphics processing hardware 329 receives information related to the vehicle from vehicle electronics system 315. Graphics processing hardware 329 may determine the acceleration of the vehicle based on the information from vehicle electronics system 315 (e.g., graphics processing hardware 329 may perform the functions of the control circuit 301). Using the determined vehicle acceleration, the graphics processing hardware 329 may manipulate the mask 301 (e.g., translate or re-render) based on the determined acceleration. In other embodiments, the graphics processing hardware 329 manipulates mask 601 based on the signals or information received from vehicle electronics system 315 directly without further processing. Graphics processing hardware 329 may manipulate mask 601 based on the output of accelerometer 319 without determining the acceleration of the vehicle. For example, graphics processing hardware 329 may translate mask 601 a number of pixels corresponding to the voltage received from accelerometer 319. Continuing the example, if the vehicle brakes causing 1 g of deceleration, the accelerometer 319 may output a corresponding voltage of 10 mV. Graphics processing hardware 329 may receive the 10 mV output from the accelerometer 319. Graphics processing hardware 329 may be configured to translate mask 601 down along the vertical axis 9 pixels for each 1 mV of the signal received from accelerometer 319 (e.g., via vehicle electronics system 315). Thus, graphics processing hardware 329 will translate mask 601 down 90 pixels in response to receiving the 10 mV signal from accelerometer 319. Advantageously, this may allow graphics processing hardware 329 to generate an image (e.g., bitmap stored in a frame buffer 307) for display without requiring processing resources or time from control circuit 301. Control circuit 301 may be dedicated to performing other tasks (e.g., generating images for other computationally intensive digital instruments such as tachometers for which minimizing performance latency is desired). This may also allow the friction bubble gauge 240 to be refreshed more quickly as intermediate steps are minimized thereby providing an advantage in that the latency of the friction bubble gauge is reduced. This configuration may also reduce the computational resource of the graphics processing hardware 329 used in generating the friction bubble gauge 240. Advantageously, this may allow more resources of graphics processing hardware 329 to be used in high computational features such as a tachometer for which low performance latency is desired.

The above described image generation functions (e.g., translating the bitmap mask 601, performing bitwise operations, etc.) may be performed by the graphics processing hardware 329. In alternative embodiments, these functions may be performed by control circuit 301 (e.g., using friction bubble display module 313 and processor 303). The resulting bitmap (e.g., the combination of mask 601, color gradient bitmap background 603, and/or labels bitmap 607) from the bitwise operations or other graphics processing generation, or manipulation techniques may be stored in one or more frame buffers 307. The frame buffer(s) 307 may be filled by graphics processing hardware 329. In alternative embodiments, the frame buffer(s) 307 are filled by control circuit 301. In one embodiment, frame buffer(s) 307 are included with processing hardware 329. In other embodiments, frame buffer(s) 307 are included with control circuit 301. One or more displays 327 may display the image (e.g., bitmap) stored in the frame buffer(s) 327. For example, a controller may read the pixel information stored in the frame buffer 327 and manipulate the hardware of display 327 in order to display the image.

Referring now to FIGS. 6A-6B and 8A-8D, the image resulting from the combination of bitmap mask 601 to color gradient bitmap background 603 using bitwise operations (e.g., bitwise and) is illustrated according to an exemplary embodiment. The color gradient bitmap background 603 and mask 601 may be combined using one or more of the techniques described herein. Referring now to FIG. 8A, the bitmap resulting from the combination of the color gradient background 603 illustrated in FIG. 6A and mask 601 illustrated in FIG. 6B is illustrated. The bubble 501 and/or mask 601 has been translated in response to acceleration to reveal a portion of color gradient bitmap background 603 corresponding to the measured acceleration of the vehicle. The portion of the color gradient bitmap background 603 revealed by mask 601 (e.g., the bubble 501 portion of mask 601) is the fill 511 of bubble 501 in the resulting bitmap. Referring now to FIG. 8B, the bitmap resulting from the combination of the color gradient background 603 illustrated in FIG. 6A and mask 601 illustrated in FIG. 6B is illustrated with a different vehicle acceleration used to manipulate mask 601. The bubble 501 and/or mask 601 has been translated in response to acceleration to reveal a portion of color gradient bitmap background 603 corresponding to the measured acceleration of the vehicle which is different from the acceleration of the vehicle corresponding to the other figures in FIGS. 8A-8D. The portion of the color gradient bitmap background 603 revealed by mask 601 (e.g., the bubble 501 portion of mask 601) is the fill 511 of bubble 501 in the resulting bitmap. Fill 511 is a different color than in the other figures as bubble 501 is in a different position relative to color gradient bitmap background 603. Referring now to FIGS. 8C and 8D, other bitmaps resulting from the combination of color gradient bitmap background 603 and mask 601 are illustrated with the vehicle having experienced different accelerations. The fill 511 is a different color due to the different position of bubble 501 and/or mask 601 relative to color gradient bitmap background 603.

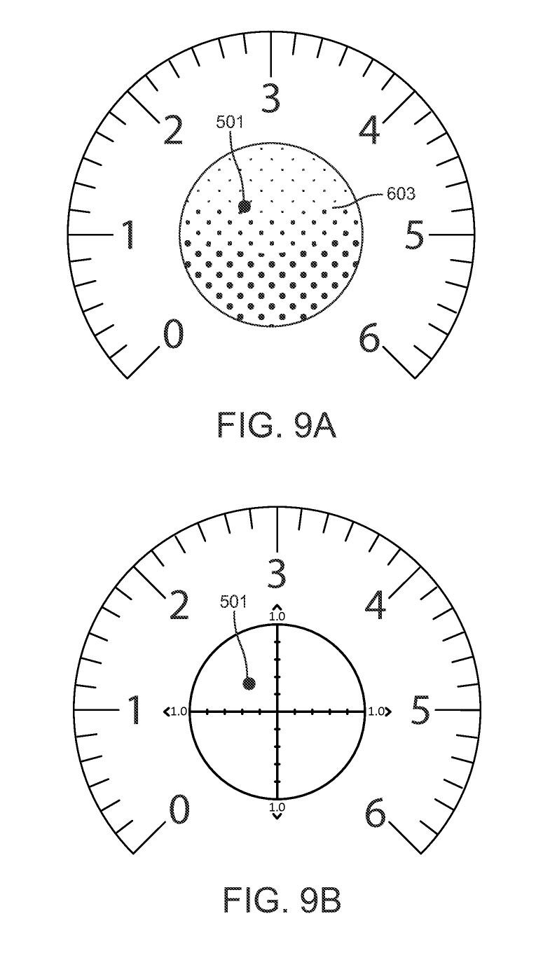

Referring now to FIGS. 9A and 9B, a color gradient bitmap background 603, bubble 501 of mask 601, and bitmap resulting from the combination of the color gradient bitmap background 603 and mask 601 are illustrated as nested within a tachometer. Referring now to FIG. 9A, a color gradient bitmap background 603 of a nested friction bubble gauge 240 is illustrated according to an exemplary embodiment. A bitmap mask 601 has been manipulated based on the acceleration of the vehicle which is illustrated with the location of the bubble 501. Referring now to FIG. 9B, a friction bubble gauge 240 is illustrated as being displayed nested within a tachometer. The friction bubble gauge 240 is a bitmap which is displayed. The bitmap is generated by combining the color gradient bitmap background 603 of FIG. 9A with the translated mask 601 depicted in FIG. 9A with bubble 501. The resulting displayed image shows bubble 501 with fill 511 corresponding to the color of the color gradient bitmap background as revealed by the mask 601. The friction bubble gauge 240 is nested within the tachometer and includes labels which may be added prior to display using labels bitmap 607 and one or more techniques described herein.

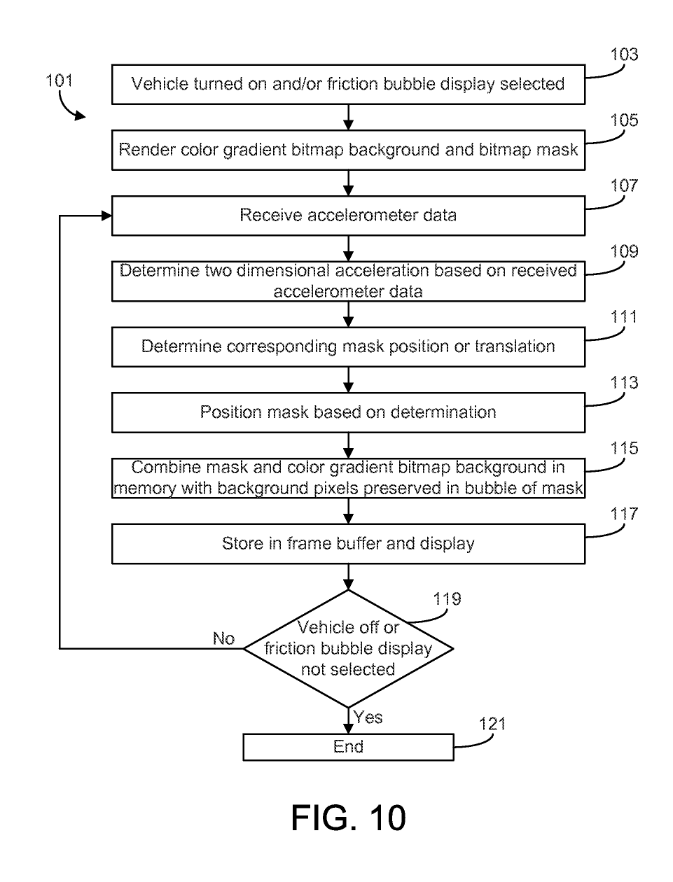

Referring now to FIG. 10, a flow chart illustrates a technique for displaying a friction bubble gauge 240 according to an exemplary embodiment. The technique may be method 101 for displaying a friction bubble gauge 240 in response to vehicle acceleration. The vehicle may be turned on and/or a friction bubble display selected (103). In some embodiments, the digital instrument system and/or vehicle is configured to display a friction bubble gauge 240 at all times when the vehicle is turned on. The user may not be able to customize a display to cause the friction bubble gauge 240 not to be displayed. The method 101 may begin when the vehicle is turned on (e.g., control circuit 301 detects that the vehicle is turned on and/or receives electrical power from the vehicle electronics system 315). In other embodiments, a user may configure the display on information in the vehicle. It may be possible to have a display configuration which does not include a friction bubble gauge 240. If a friction bubble gauge 240 is not being displayed to a vehicle occupant, the remaining steps of method 101 may not be taken. In other words, if the friction bubble gauge 240 is not selected to be displayed, control circuit 301 and/or graphics processing hardware 329 will not determine vehicle acceleration and generate the image of the friction bubble gauge 240. This may conserve processing resources. In some embodiments, control circuit 301 is configured to determine if a friction bubble gauge 240 has been selected for display by a user. For example, control circuit 301 may handle user inputs related to customization of a digital instrument system. Upon receiving an input which corresponds to displaying a friction bubble gauge 240, the control circuit 301 may determine that the friction bubble gauge 240 has been selected for display and continue with the steps of method 101. In some embodiments, control circuit 301 may read memory 305 to determine if the friction bubble gauge 240 is to be displayed (e.g., based on user configuration settings store din memory 305).

In some embodiments, the color gradient bitmap background mask 603 and/or mask 601 are rendered (105). This may be pre-rendering of the color gradient bitmap mask 603 and/or mask 601 before use in the following steps. The graphics processing hardware 329 may render the graphics assets. Alternatively, control circuit 301 may render the graphics assets. The rendered color gradient bitmap background mask 603 and/or mask 601 may be stored in memory 305. In other embodiments, this step is omitted. The pixel information for the color gradient bitmap background 603, mask 601, and/or labels bitmap 607 may be stored in memory 305 such that the graphics assets are pre-rendered and no additional processing is performed until the friction bubble gauge image is generated using the graphics assets as explained in the following steps.

Accelerometer data may be received (107). In one embodiment, the control circuit 301 receives accelerometer data from accelerometer 319 and/or vehicle electronics system 315. In other embodiments, accelerometer data may be received by graphics processing hardware 329 from accelerometer 319 and/or vehicle electronics system 315.

The two dimensional acceleration of the vehicle may be determined based on the received accelerometer data (109). In one embodiment, the control circuit determines the two dimensional acceleration of the vehicle. For example, the control circuit may determine the two dimensional acceleration using algorithm stored in memory 305 (e.g., a portion of code in friction bubble display module 313) and processor 303. The algorithm as implemented by the control circuit 301 may use one or more of a variety of techniques to determine acceleration of the vehicle in the direction of travel and laterally such as the techniques described herein (e.g., using a multi-axis accelerometer). In other embodiments, the graphics processing hardware 329 may determine the acceleration of the vehicle. In still further embodiments, this step may be skipped.

A mask 601 position or translation may be determined which corresponds to the determined two dimensional acceleration of the vehicle (111). In one embodiment, the position of the mask 601 is determined. The mask 601 may be positioned in a pixel coordinate system based on the determined acceleration. For example, the mask 601 may have dimensions of 360 pixels by 360 pixels. The friction bubble gauge may be displayed as a 180 pixel by 180 pixel image. The color gradient bitmap background may be 180 pixels by 180 pixels with a position in a pixel coordinate system corresponding to the pixels to be displayed (e.g., stored in the frame buffer). The mask 601 may include a bubble 501 at the center of the mask 601. Based on the determined acceleration, the mask 601 may be placed at a specific position within pixel coordinate system. For example, if an acceleration of the vehicle is determined to be 1 g forward and 0.5 g to the right, the mask 601 may be positioned with its center at 162 pixels vertically and 126 pixels horizontally from the lower left hand corner of the pixel coordinate system (e.g., with the origin being the lower left hand corner 0,0 of the 180 by 180 pixel field).

In one embodiment, translation values are determined for the mask 601 which correspond to the change in acceleration of the vehicle. Mask 601 may be moved (e.g., translated) from its last position rather than positioned from the same starting point during each iteration of the method 101. For example, the vehicle may start with zero acceleration. During a first iteration, acceleration may be detected to be 0.1 g in a straight line (e.g., throttle is applied without turning the vehicle). The change in acceleration from 0 to 0.1 g may be determined to correspond to 7 pixels (e.g., a linear relationship between acceleration and pixels, a friction bubble gauge with a maximum g of 1.25, and a color gradient bitmap background of 180 pixels by 180 pixels). The mask 601 may be moved upward 7 pixels (e.g., at step 113). During a second iteration, the acceleration may be found to be 0.4 g forward. The difference between current acceleration 0.4 g and past acceleration 0.1 g may be determined to be 0.3 g which corresponds to 22 pixels. The mask 601 may be moved up 22 pixels (e.g., at step 113).

In other words, the acceleration of the vehicle may be converted into pixel values using a formula that equates acceleration to pixels. Schemes alternative those described above may be used. For example, the origin of the pixel coordinate system may be placed at the center of the color gradient bitmap background 603. Acceleration forward and acceleration to the right may correlate to a positive number of pixels. For example, forward acceleration of 1.25 g may be 90 pixels, acceleration of 1 g may be 72 pixels, etc. In other embodiments, the relationship between acceleration and pixels may be non-linear. For example, the relationship between acceleration and pixels may be exponential, logarithmic, geometric, or another relationship. As previously explained above, in one embodiment bubble 501 may be translated or positioned relative to mask 601 rather than mask 601 being translated or moved relative to color gradient bitmap background 603. In such an embodiment, mask 601 may have the pixel dimensions as color gradient bitmap background 603.

In embodiments in which no determination of two dimensional acceleration is made (e.g., step 107 is skipped), mask 601 position or translation may be determined directly from the output of accelerometer 319 as described above. For example, graphics processing hardware 329 may translate or position mask 601 based on voltage received from accelerometer 319.

The mask 601 may be positioned or translated based on the determination of the position or translation values corresponding to the acceleration of the vehicle (113). For example, in embodiments where the mask 601 is positioned, the pixel values of the mask 601 stored in memory 305 at a first location may be copied, manipulated, and stored in memory 305 at a second location. The manipulation may perform the positioning of the mask 601 by moving values associated with one pixel location to a different pixel location. For example, in embodiment where the mask 601 is translated, the pixel values of the mask stored in memory 305 at a first location may be read, manipulated, and store at the first location. Thus, the previous pixel values are maintained such that the mask 601 may be translated. Other techniques may be used such that the mask 601 is positioned or translated within a coordinate system relative to the color gradient bitmap background 603.

The mask 601 and the color gradient bitmap background 603 may be combined such that the pixel information of the color gradient bitmap background 603 corresponding to pixels in the same location as the bubble 501 of mask 601 is preserved (115). Other information may be overwritten by mask 601. The combined bitmap may be stored in a memory location which is distinct from the memory location of the color gradient bitmap background 603 and bitmap mask 601. This allows the pre-rendered graphics assets (the mask 601 and color gradient bitmap background 603) to remain unchanged and available for use in subsequent iterations. In one embodiment, bitmap mask 601 and color gradient bitmap background 603 are combined using bitwise operations. For example, the bit values of the color gradient bitmap background 603 and bitmap mask 601 may be set such that a bitwise operation AND causes the color gradient bitmap background 603 to be preserved for pixels of the mask 601 making up the bubble 501, while all other pixels of the of color gradient bitmap background 603 are overwritten with the pixel values of the portion of mask 601 which is not bubble 501. This may result in an image in which bubble 501 and fill 511 are the color of the color gradient bitmap background 603 while the remainder of the image is black.

Continuing the example, the pre-rendered color gradient bitmap background may be stored in memory 305 with pixel information (e.g., information describing the color of the pixel and location of the pixel) for each pixel along with a pixel value. The pixel value may be a bit associated with each pixel used in combining bitmaps. The mask 601 may also contain this information (e.g., pixel information and pixel value) for each pixel stored in memory 305. The pixel information for mask 601 may be manipulated in the above described steps for purposes of generating an image in response to vehicle acceleration. The pixel value of all pixels of color gradient bitmap background 603 may be 1 so as to preserve the pixel information. The pixel values of the bubble portion of mask 601 be 1 so as to preserve pixel information from the color gradient bitmap background 603 pixels corresponding to the bubble 501 pixels. The remaining pixels of bitmap mask 601 may have a pixel value of 0 such that the corresponding pixel information of color gradient bitmap background 603 is overwritten. The bitwise operation and may be performed on color gradient bitmap background 603 and mask 601 with the result stored in a memory location distinct from the locations of the color gradient bitmap background 603 and mask 601. Therefore, the pixel information of the color gradient bitmap background 603 is overwritten except for the portion corresponding to the bubble 501 of bitmap mask 601. The color of the color gradient bitmap background 603 is preserved for the portion of the mask 601 corresponding to bubble 501 and no color remains for the rest of the resulting bitmap. In some embodiments, a further bitwise or operation is used to add the pixel information of the mask 601 for pixels other than the bubble 501. This may cause the resulting bitmap to have pixel information from the color gradient bitmap background 603 for pixels corresponding to the location of bubble 501 and have pixel information corresponding to the portions of mask 601 other than the bubble 501 for pixels corresponding to locations other than that of bubble 501. The resulting bit map may contain pixel information which causes the display of a colored bubble 501 with all other pixels of the display 327 either off or displaying black.

In some embodiments, other techniques are used in addition to or in place of the bitwise operations described herein to combine the mask 601 and the color gradient bitmap background 603. For example, blitting, the use of transparent colors, alpha compositing, and/or other rendering or image generation techniques may be used in place of or in combination with bitwise operations such as those described above. In further embodiments, the labels bitmap 607 is added to the resulting bitmap using bitwise operations or other techniques. This may result in an image of the friction bubble gauge 240 including a colored bubble 501 positioned relative to axis, labels, and/or other features.

The resulting bitmap may be stored in a frame buffer 307 and displayed (117). In one embodiment, the resulting bitmap is stored in a frame buffer 307 included in graphics processing hardware 329. In other embodiments, the resulting bitmap is stored in a frame buffer 307 included in control circuit 301. The information stored in frame buffer 307 may be used to display an image of the friction bubble gauge 240 on one or more displays 327. For example, a controller may read the information from the frame buffer 307 and cause the hardware of display 327 to display the image.

The control circuit may then determine if the vehicle is off or the friction bubble gauge 240 is not selected for display. If the control circuit determines that the vehicle is off (e.g., no power is provided by vehicle electronics system 315), the method 101 may end (121). If the control circuit determines that the friction bubble gauge 240 is no longer selected to be displayed (e.g., a user changes a display from one digital instrument to another), the method 101 may end. If the control circuit determines that the vehicle is not off and that the friction bubble gauge 240 is selected for display, then the steps described above may go through another iteration. The control circuit 301 or graphics processing hardware 329 may receive accelerometer data (107).

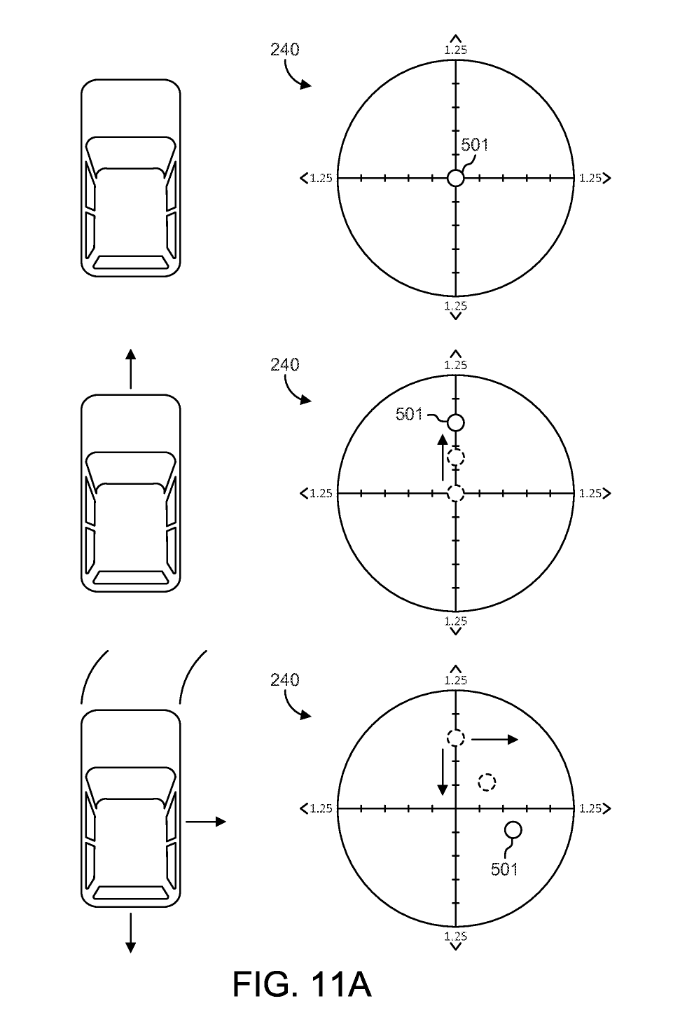

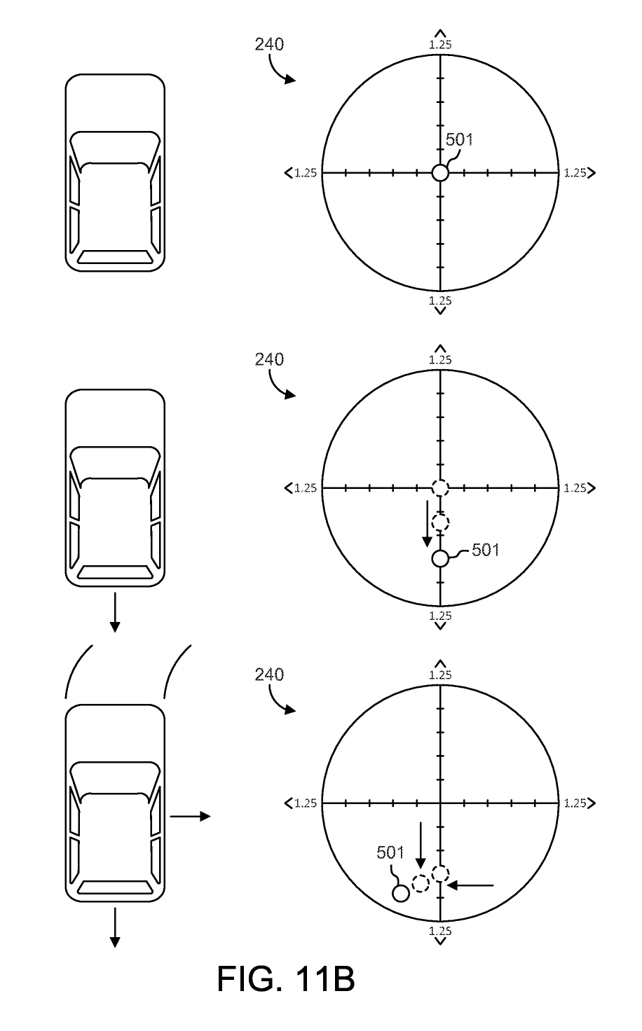

Referring now to FIGS. 11A and 11B, vehicle acceleration and the resulting changes in friction bubble gauge 240 are illustrated according to an exemplary embodiment. Referring now to FIG. 11A, vehicle acceleration and the corresponding changes in the displayed friction bubble gauge 240 for an acceleration based system are illustrated according to an exemplary embodiment. In response to a vehicle experiencing no acceleration (e.g., stationary or moving at a constant velocity), friction bubble gauge 240 shows bubble 501 at the center point of friction bubble gauge 240. In response to a vehicle experiencing forward acceleration (e.g., due to increased throttle), the friction bubble 240 shows bubble 501 in the upper hemisphere and along the vertical axis. As acceleration increases, the bubble 501 moves further from the center point of friction bubble gauge 240. In response to a vehicle experiencing deceleration in a straight line and acceleration to the right (e.g., due to braking and turning right), the friction bubble gauge 240 shows bubble 501 moving towards and into the lower hemisphere and right hemisphere.

Referring now to FIG. 11B, vehicle acceleration and the corresponding changes in the displayed friction bubble gauge 240 for an acceleration and g force acceleration component based system are illustrated according to an exemplary embodiment. As explained above, the friction bubble gauge may display the acceleration component of g force (e.g., negative acceleration) rather than the acceleration of the vehicle. For example, lateral acceleration toward the right (e.g., a right hand turn) will result in the display on friction bubble gauge 240 of bubble 501 moving to the left. In response to a vehicle experiencing no acceleration (e.g., stationary or moving at a constant velocity), friction bubble gauge 240 shows bubble 501 at the center point of friction bubble gauge 240. In response to a vehicle experiencing straight line deceleration (e.g., due to braking), the friction bubble 240 shows bubble 501 in the lower hemisphere and along the vertical axis (i.e., true acceleration). As deceleration increases (e.g., the vehicle slows more rapidly), the bubble 501 moves further from the center point of friction bubble gauge 240. In response to a vehicle experiencing deceleration in a straight line and acceleration to the right (e.g., due to braking and turning right), the friction bubble gauge 240 shows bubble 501 moving towards and into the lower hemisphere and left hemisphere.

Referring now to FIGS. 11A and 11B, friction bubble gauge 240 may display true acceleration values, inertial (e.g., g force acceleration component) values, or a combination of true acceleration and g-force. In one embodiment, as the vehicle accelerates, bubble 501 moves toward and/or into the lower hemisphere. As the vehicle decelerates (e.g., due to braking or reverse movement), bubble 501 moves toward and/or into the upper hemisphere. As the vehicle turns left, bubble 501 moves toward and/or into the left hemisphere. As the vehicle turns right, bubble 501 moves toward and/or into the right hemisphere.

In some embodiments, the bubble 501 may be shown as travelling from one acceleration value to another rather than instantaneously appearing at the current acceleration value. Control circuit 301, friction bubble display module 313, memory 305, and/or graphics processing hardware 329 may be used to create a series of images (e.g., using the techniques described above) which show the bubble 501 moving between true values of acceleration. Advantageously, this may make friction bubble gauge 240 easier to read as the bubble 501 follows a path of movement rather than jumping from one location to another. For example, a vehicle may be accelerating at 1 g and as soon as the brakes are applied acceleration is 0 or there is deceleration. Rather than showing friction bubble 501 moving from 1 g positive straight line acceleration to positive deceleration or no acceleration, a series of images may be displayed with bubble 501 gradually moving from 1 g to the 0 g or deceleration. In other words as the vehicle switches from acceleration to deceleration in any direction, bubble 501 may be depicted as showing vehicle acceleration for several images in a series of images until bubble 501 shows the current value of deceleration.

In further embodiments, friction bubble 240 may display ghost bubbles along with bubble 501. Ghost bubbles may correspond to the previous positions of bubble 501. Ghost bubbles may not have a color fill but instead be represented as white unfilled circles. Ghost bubbles may fade over time. Ghost bubble may indicate a set number of previous bubble 501 locations (e.g., 5). Ghost bubbles may cease to be shown if the ghost bubble corresponds to location of the bubble 501 that is not one of the last set number of locations or sufficient time has elapsed such that the ghost bubble has faded. Advantageously, the use of ghost bubbles may make friction bubble gauge 240 easier to read as the path of bubble 501 is indicated by a series of ghost bubbles (e.g., 5 at a time). This may assist a vehicle occupant in determining the trend of acceleration as the pervious acceleration values (e.g., ghost bubbles) are illustrated along with the current acceleration value (e.g., bubble 501).

The use of bitwise operations have been described to combine the mask 601 and color gradient bitmap background 603 in such a way as the mask 601 reveals a portion of the color gradient bitmap background 603 and conceals the remainder. Other techniques may be used to produce the above described combination of the mask 601, color gradient bitmap background 603, and/or labels bitmap 607. For example, blitting, the use of transparent colors, alpha compositing, and/or other rendering or image generation techniques may be used in place of or in combination with bitwise operations such as those described above.

Generally, techniques other than the bitmap mask technique described above may be used to generate the friction bubble gauge 240. In one embodiment, computer code (e.g., stored in friction bubble display module 313) is used to change the color of bubble 501 corresponding to the intensity (e.g., magnitude) of the acceleration of the vehicle. For example, an algorithm or program may determine the color corresponding to the determined acceleration. A look up table may be used to determine the color (e.g., red, green, and blue color components) of the color associated with the determined acceleration. The control circuit 301 may then send instructions to graphics processing hardware 329 which causes the graphics processing hardware 329 to render an image (e.g., bitmap) including the bubble 501 in the location corresponding to the measured acceleration and with the color fill 511 corresponding to the measured acceleration. For each newly determined acceleration values for the vehicle, the bitmap of friction bubble gauge 240 may be rendered. In other words, each time friction bubble gauge 240 is displayed it is rendered prior to display (e.g., real time rendering). In alternative embodiments, control circuit 301 may render the bitmap of friction bubble gauge 240 each time prior to display (e.g., prior to the bitmap being stored in a frame buffer 307). This differs from the technique described above in that in the above described technique (e.g., using bitwise operations) the graphics assets may be pre-rendered.

The use of pre-rendered graphics assets and/or the techniques described above (e.g., the use of bitwise operations and shifting the mask 601) may provide an advantage over the use of code to render a bitmap of friction bubble gauge 240 each time prior to display (e.g., using code to determine the color of bubble 501). Using code to determine the color of the bubble 501 and rendering a corresponding bitmap each time friction bubble gauge 240 is updated may be processor intensive. The use of code to determine the color of bubble 501 may require greater amounts of processing time or other computing resources in comparison to the use of pre-rendered graphics assets. Additionally, the use of code to determine the color of bubble 501 may affect the performance of the graphic movement with latencies which make friction bubble gauge 240 more difficult to read or unpleasant to view by a vehicle occupant.

Using pre-rendered graphics assets and the techniques described above (e.g., bitwise operations) to color bubble 501 may be quicker than using code to determine the color of bubble 501 and rendering a corresponding bitmap. Using pre-rendered graphics assets and the techniques described above may also require fewer processing resources to display the friction bubble gauge 240. Advantageously, the techniques described above with reference to FIGS. 5-10 (e.g., translation based on determined acceleration and bitwise operations) and the use of pre-rendered graphics assets may eliminate the need for code to change the color of bubble 501 (e.g., red, blue, and green color values are not looked up in a table rather mask 601 is translated and combined with color gradient bitmap background 603). This may free up processor resources (e.g., processing time) for use on other tasks. For example, the processor may handle other simultaneous processing intensive tasks, such as tasks related to displaying a tachometer, for which low performance latency is desired or required.

The use of mask 601 and color gradient bitmap background 603 as described herein to generate images of friction bubble gauge 240 may provide the above described advantages (e.g., lower latency, use of less computational resources, etc.) over a system which uses code to determine the color of bubble 501 and renders a bitmap of friction bubble gauge 240 iteratively. In some embodiments, the use of code to determine the color of bubble 501 may be used instead of the mask 601 and color gradient bitmap background 603 based techniques previously described.

The techniques described above, using a mask 601 and color gradient bitmap background 603 and/or using computer code and real time rendering, may be used to generate digital instruments other than a friction bubble gauge 240. For example, digital instruments such as tachometers, speedometers, oil pressure gauges, oil temperature gauges, vehicle position displays, and other digital instruments may be generated using the techniques described herein. By altering the geometry of mask 601, color gradient bitmap background 603, and/or label bitmap 607, different digital instruments may be generated. The techniques described above (e.g., those described with reference to FIG. 10) may be used in combination with pre-rendered graphics (e.g., mask 601, color gradient bitmap background 603, and/or label bitmap 607) corresponding to each digital instrument which is displayed using the mask 601 and color gradient bitmap background 603 based technique.

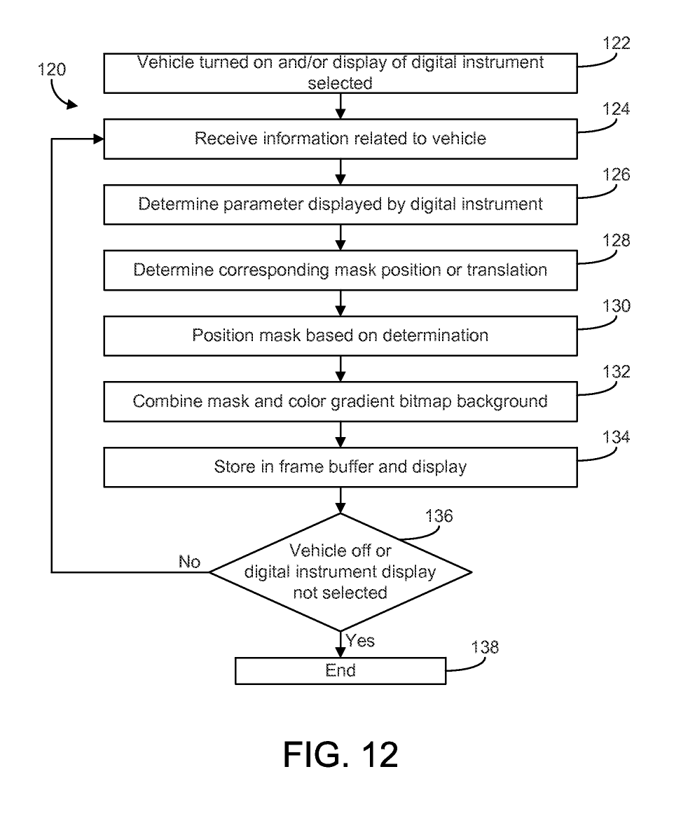

Referring now to FIG. 12, a general glow chart illustrates the steps of method 120 for generating a digital instrument using a mask 601 and color gradient bitmap background 602 according to an exemplary embodiment. The steps illustrated herein may be executed in the same or similar manner as described above with respect to FIG. 10. The digital instrument system may determine if the vehicle is turned on and/or the display of a particular digital instrument has been selected (122). In some embodiments, the digital instrument system and/or vehicle is configured to display a particular digital instrument at all times when the vehicle is turned on. The user may not be able to customize a display to cause the friction bubble gauge 240 not to be displayed. In other embodiments, a user may configure the display on information in the vehicle. It may be possible to have a display configuration which does not include a particular digital instrument. If a particular digital instrument is not being displayed to a vehicle occupant, the remaining steps of method 101 may not be taken. In some embodiments, control circuit 301 is configured to determine if a particular digital instrument has been selected for display by a user. The color gradient bitmap background 603 and/or mask 601 for a particular digital instrument may be pre-rendered (e.g., stored in memory 305). Control circuit 301 may select the color gradient bitmap background 603 and mask 601 corresponding to the particular digital instrument which is being displayed.

Information related to the vehicle may be received (124). In one embodiment, the control circuit 301 receives the information from vehicle electronics system 315. In other embodiments, information related to the vehicle may be received by graphics processing hardware 329 from vehicle electronics system 315.

One or more parameters which are displayed by the particular digital instrument may be determined (126). In one embodiment, the control circuit 301 determines the parameter. For example, the control circuit 301 may determine the parameter using algorithm stored in memory 305 (e.g., a portion of code in a module) and processor 303. In other embodiments, the graphics processing hardware 329 may determine the parameter. In still further embodiments, this step may be skipped.

A mask 601 position or translation may be determined which corresponds to the determined parameter (128). In one embodiment, the position of the mask 601 is determined. The mask 601 may be positioned in a pixel coordinate system based on the determined parameter. In one embodiment, translation values are determined for the mask 601 which correspond to the determined parameter or change in the determined parameter. Mask 601 may be moved (e.g., translated) from its last position rather than positioned from the same starting point during each iteration of the method 120. In embodiments in which no determination of the parameter is made (e.g., step 126 is skipped), mask 601 position or translation may be determined directly from the output of sensors 317. For example, graphics processing hardware 329 may translate or position mask 601 based on voltage received from a sensor 317.

The mask 601 may be positioned or translated based on the determination of the position or translation values corresponding to the parameter (130). For example, in embodiments where the mask 601 is positioned, the pixel values of the mask 601 stored in memory 305 at a first location may be copied, manipulated, and stored in memory 305 at a second location. The manipulation may perform the positioning of the mask 601 by moving values associated with one pixel location to a different pixel location. For example, in embodiment where the mask 601 is translated, the pixel values of the mask stored in memory 305 at a first location may be read, manipulated, and store at the first location. Thus, the previous pixel values are maintained such that the mask 601 may be translated. Other techniques may be used such that the mask 601 is positioned or translated within a coordinate system relative to the color gradient bitmap background 603.

The mask 601 and the color gradient bitmap background 603 may be combined (132). The mask 601 and the color gradient bitmap background 603 may be combined such that the pixel information of the color gradient bitmap background 603 corresponding to pixels in the same location as the bubble 501 of mask 601 is preserved. The combined bitmap may be stored in a memory location which is distinct from the memory location of the color gradient bitmap background 603 and bitmap mask 601. This allows the pre-rendered graphics assets (the mask 601 and color gradient bitmap background 603) to remain unchanged and available for use in subsequent iterations. In one embodiment, bitmap mask 601 and color gradient bitmap background 603 are combined using bitwise operations. In some embodiments, other techniques are used in addition to or in place of the bitwise operations described herein to combine the mask 601 and the color gradient bitmap background 603. For example, blitting, the use of transparent colors, alpha compositing, and/or other rendering or image generation techniques may be used in place of or in combination with bitwise operations such as those described above. In further embodiments, the labels bitmap 607 is added to the resulting bitmap using bitwise operations or other techniques. This may result in an image of the friction bubble gauge 240 including a colored bubble 501 positioned relative to axis, labels, and/or other features.

The resulting bitmap may be stored in a frame buffer 307 and displayed (134). In one embodiment, the resulting bitmap is stored in a frame buffer 307 included in graphics processing hardware 329. In other embodiments, the resulting bitmap is stored in a frame buffer 307 included in control circuit 301. The information stored in frame buffer 307 may be used to display an image of the particular digital instrument on one or more displays 327. For example, a controller may read the information from the frame buffer 307 and cause the hardware of display 327 to display the image.

The control circuit may then determine if the vehicle is off or the particular digital instrument is not selected for display. If the control circuit determines that the vehicle is off (e.g., no power is provided by vehicle electronics system 315), the method 120 may end (138). If the control circuit determines that the particular digital instrument is no longer selected to be displayed (e.g., a user changes a display from one digital instrument to another), the method 120 may end. If the control circuit determines that the vehicle is not off and that the particular digital instrument is selected for display, then the steps described above may go through another iteration. The control circuit 301 or graphics processing hardware 329 may receive information related to the vehicle (122).

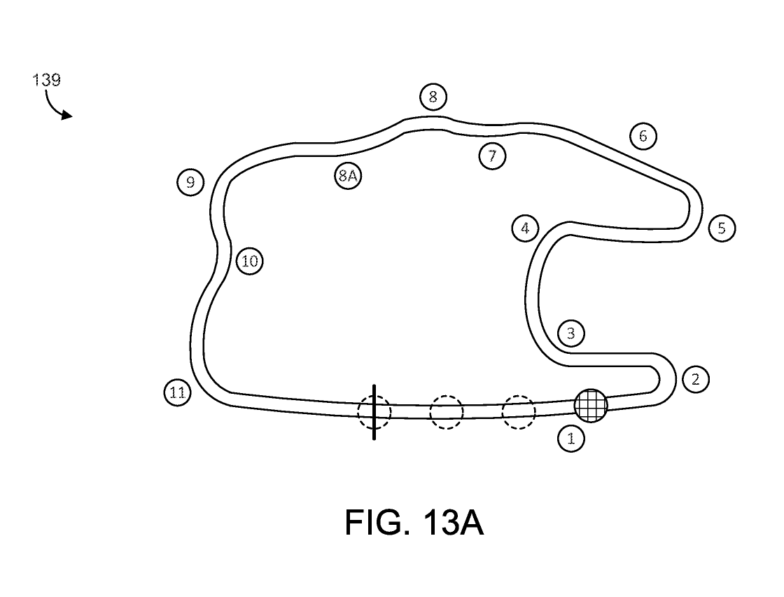

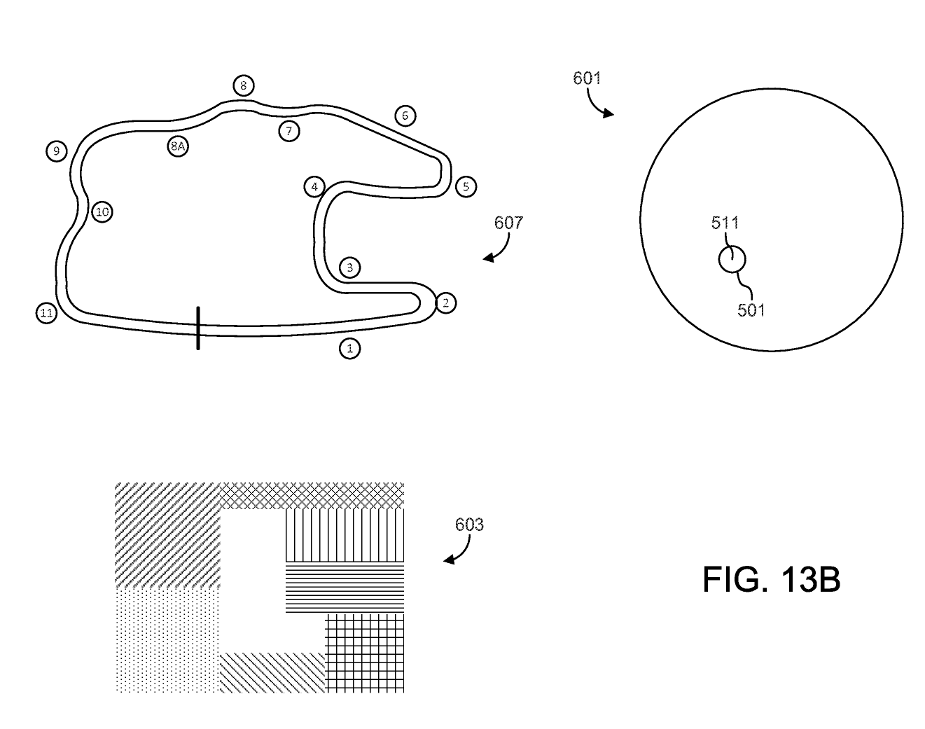

Referring now to FIG. 13A, a track position gauge 139 digital instrument is illustrated according to an exemplary embodiment. Track position gauge 139 may display information to a vehicle occupant on one or more display 327. The information may be the position of the vehicle in relationship to a road or track. For example, the portion of the track on which the vehicle is currently travelling may be indicated with a bubble 501 of a particular color. In other embodiments, the information may be vehicle dynamics (e.g., whether the vehicle accelerated or decelerated) corresponding to that portion of the track. One or more of the above described techniques may be used to generate the track position gauge 139. The track position gauge 139 may be generated based on vehicle position information generated by vehicle electronics system 315. For example, vehicle electronics system 315 may include a GPS transceiver and/or dead reckoning system.

Referring now to FIG. 13B, track position gauge 139 may be generated using the techniques described with reference to FIG. 12 and pre-rendered graphics such as those illustrated according to an exemplary embodiment. The color gradient bitmap background 603 may be a pre-rendered graphics asset particular to the track position gauge 139. The color gradient bitmap background 603 may also be particular to a specific road or track. Mask 601 may include a bubble 501 and fill area 511. In some embodiments, bubble 501 may have a different geometry. For example, bubble 501 may be shaped like the silhouette of a vehicle. A labels bitmap 607 may be used to provide labels to the track position gauge 139. For example, labels bitmap 607 may include an outline of the road or track, turn numbering, a start/finish line, and/or other labels. Using the techniques described herein, the mask 601, color gradient bitmap background 603, and/or labels bitmap 607 may be manipulated and combined based on information related to the vehicle to generate track position gauge 139.

Generally, other digital instruments may be produced using the techniques described herein. Different masks 601, color gradient bitmap backgrounds, and/or labels bitmaps 607 may be used in the generation of each digital instrument. Control circuit 301 and/or graphics processing hardware 329 may select the corresponding graphics assets for a particular digital instrument which is being generated and/or displayed. Thus, a plurality of digital instruments may be generated and displayed using sets of pre-rendered graphics assets. In some embodiments, digital instruments may be generated with a modified version of the techniques described herein. For example, mask 601 may remain stationary while color gradient bitmap background 603 is translated or positioned. Continuing the example, a digital instrument may be a torque meter in which a vehicle image changes color corresponding to the amount of torque being produced by the vehicle engine. The mask 601 may have a bubble shaped like a vehicle silhouette. Color gradient bitmap background 603 may be translated in response to the determined torque of the engine (e.g., based on information related to the vehicle from vehicle electronics system 315). The mask 601 and color gradient bitmap background 603 may then be combined to produce a bitmap of the torque gauge. Other modifications to the techniques described herein may be made in order to generate digital instruments.

In some embodiments, digital instruments (e.g., friction bubble gauge 240) may be customized by a user or vehicle occupant. Customization inputs may be received by the control circuit 301 via vehicle electronics system 315 or other input hardware. Customization may include selecting or altering the size of a digital instrument, the position of a digital instrument on a display 327, the display 327 on which the digital instrument in displayed, or other characteristics of the digital instrument. The content of a digital instrument may also be customizable. A user or vehicle occupant may customize the labels of a digital instrument, the scale on which information is displayed, the units for which information is displayed, the maximum and minimum values displayed, and/or other content of a digital instrument.

In some embodiments, control circuit 301 and/or graphics processing hardware 329 select or otherwise use a corresponding pre-rendered graphics asset which corresponds to the user customization. For example, friction bubble gauge 240 may be displayed with a maximum g value of 1.25 by default. A user may customize friction bubble gauge 240 such that the maximum g value which may be displayed by friction bubble gauge 240 is 1.5 g. In response, control circuit 301 and/or graphics processing hardware 329 may select from memory 305 or otherwise use corresponding pre-rendered graphics assets. A labels bitmap 607 with the labels 1.25 g and a color gradient bitmap background 603 with corresponding colors may be stored in memory for use when the friction bubble gauge 240 has a maximum value of 1.25 g. A second set of pre-rendered graphics assets may be stored in memory for use when the friction bubble gauge 240 has a maximum value of 1.5 g. A labels bitmap 607 with the labels 1.5 g and a color gradient bitmap background 603 with corresponding colors may be used. Memory 305 may include pre-rendered graphics assets for all combinations of digital instruments which the user may select through user customization.

In other embodiments, control circuit and/or graphics processing hardware 329 render graphics assets based on the inputs of the user (e.g., user customization) prior to the display of the digital instrument. These graphics assets may then function as pre-rendered graphics assets for the display of the digital instrument. In other words, once rendered based on the user customization inputs, the graphics assets are not re-rendered or re-rendered in real time. In some embodiments, one or more algorithms, code, programs, and/or instructions used in the techniques described herein take into account user customization information. For example, a user may change the scale of a digital instrument from a linear scale to a logarithmic scale. The labels bitmap 607 and/or color gradient bitmap background 607 may be adjusted to reflect this change. The translation of the mask 601 corresponding to the information related to the vehicle is also adjusted. For example, with a linear scale, control circuit 301 may determine how may pixels to translate mask 601 in response to a determined acceleration using a linear relationship (e.g., function) relating the determined acceleration to the number of corresponding pixels mask 601 is translated. With a logarithmic scale, control circuit 301 may use a different and logarithmic function to relate the determined acceleration to the number of corresponding pixels mask 601 is translated.

In some embodiments, the motion of a bubble 501 in friction bubble gauge 240 may be adjusted through user customization. The bubble 501 may move linearly with the acceleration of the vehicle. The bubble 501 may move at varying degrees of exponentialality based on a parameter customized by the user. In some embodiments, the user may customize the position and/or number of scale marks 507 (e.g., tick marks). For example, a user may change a default value of a scale mark 507 every 0.25 g to a scale mark 507 every 0.5 g. In some embodiments, friction bubble gauge 240 may be displayed with damping. The bubble 501 may be damped so as to provide slower and/or smoother changes in direction of bubble 501 when viewed by a vehicle occupant. The amount of movement damping may be customizable by the user. In some embodiments, the friction bubble gauge 240 uses a threshold value of acceleration or acceleration component of g force. The threshold value may be used to prevent the display (e.g., by moving bubble 501) of changes in acceleration which do not exceed the threshold. For example, the threshold value may be 0.08 g. In some embodiments, the threshold value may be customizable by a user.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. An apparatus for displaying information to an occupant of a vehicle, comprising:
a display coupled to the vehicle, the display configured to display an image based on information stored in a frame buffer; and
a control circuit coupled to the display, the control circuit configured to receive information related to the vehicle from a vehicle electronics system,
wherein the control circuit is configured to display a digital instrument based on the information related to the vehicle by revealing a color gradient bitmap background using a bitmap mask and storing the result in the frame buffer, and wherein the bitmap mask is moved relative to the color gradient bitmap.

2. The apparatus of claim 1, wherein at least one of the color gradient bitmap background and bitmap mask is a pre-rendered graphics asset stored in memory included in the control circuit.

3. The apparatus of claim 1, wherein the control circuit includes graphics processing hardware.

4. The apparatus of claim 3, wherein the control circuit uses the graphics processing hardware to perform hardware acceleration and to reveal the color gradient bitmap background using the bitmap mask and store the result in the frame buffer.

5. The apparatus of claim 1, wherein the control circuit sends an instruction to graphics processing hardware, separate from the control circuit and in communication with the control circuit, which causes the graphics processing hardware to fill a frame buffer by combining a bitmap mask and color gradient bitmap background with a bitwise operation based on information related to the vehicle.

6. The apparatus of claim 5, wherein the information related to the vehicle is at least vehicle acceleration, and wherein the bitmap mask and the color gradient bitmap background form a digital instrument which displays acceleration information.

7. The apparatus of claim 1, wherein the control circuit does not manipulate a graphics asset, and wherein the control circuit passes information related to the vehicle to graphics processing hardware.

8. The apparatus of claim 7, wherein the graphics processing hardware is configured to fill a frame buffer by combining a bitmap mask and color gradient bitmap background with a bitwise operation based on the information related to the vehicle, and wherein the bitmap mask is moved relative to the color gradient bitmap background based on the information related to the vehicle.

9. A method for displaying vehicle information to a vehicle occupant, comprising:
receiving, at a control circuit, information related to a vehicle from a vehicle electronics system;
processing the information related to the vehicle using the control circuit to result in vehicle information;
determining bitmap mask translation values based on the vehicle information;
translating a bitmap mask based on the bitmap translation values;
filling a frame buffer by revealing a portion of a color gradient bitmap background using the bitmap mask; and
displaying the vehicle information on a vehicle display based on the frame buffer.

10. The method of claim 9, wherein at least one of the color gradient bitmap background and the bitmap mask is a pre-rendered graphics asset.

11. The method of claim 9, wherein the frame buffer is filled using at least one of a shader and compositor.

12. The method of claim 11, wherein the frame buffer is filled using an application programming interface and hardware-accelerated rendering.

13. The method of claim 12, wherein a graphics processing unit performs the hardware-accelerated rendering.

14. The method of claim 12, wherein at least one of a shader and compositor performs the hardware-accelerated rendering.

15. The method of claim 9, wherein the information related to the vehicle is vehicle acceleration, and wherein the frame buffer is filled with an image of a friction bubble gauge configured to include information about the two dimensional acceleration of the vehicle.

16. A digital gauge for displaying information to an occupant of a vehicle, comprising:
a display coupled to the vehicle;
a vehicle electronics system configured to provide information related to the vehicle; and
a control circuit configured to provide information to the vehicle occupant by causing the display of vehicle information on the display,
wherein the vehicle information displayed is an icon which changes color as it moves relative to a boundary of the digital gauge.

17. The apparatus of claim 16, wherein the control circuit is configured to display the vehicle information by rendering the color of the icon and the location of the icon as a single image.

18. The apparatus of claim 16, wherein the control circuit is configured to display the vehicle information by revealing a color gradient bitmap background using a bitmap mask in response to vehicle information.

19. The apparatus of claim 16, wherein the icon is a bubble which is positioned relative to the boundary of the digital gauge based on the magnitude and direction of the acceleration of vehicle, and wherein the color of the bubble changes based on the magnitude of the acceleration of the vehicle.

20. The apparatus of claim 16, wherein the icon is a bubble which is positioned relative to the boundary of the digital gauge based on the position of the vehicle, and wherein the color of the bubble changes based on the position of the vehicle.
